(19) United States
(12) Patent Application Publication
(10) Pub. No.: US 2015/0033016 A1
(43) Pub. Date: Jan. 29, 2015

(54) SYSTEMS AND METHODS FOR SECURING REAL-TIME MESSAGES

(71) Applicant: Battelle Memorial Institute, Columbus, OH (US)

(72) Inventors: Douglas A. Thornton, Columbus, OH (US); Katherine M. Weaver, Columbus, OH (US)

(21) Appl. No.: 14/339,128

(22) Filed: Jul. 23, 2014

Related U.S. Application Data
(60) Provisional application No. 61/857,348, filed on Jul. 23, 2013.

(51) Int. Cl. H04L 9/08; H04L 29/06

(52) U.S. Cl. CPC H04L 9/0825; H04L 63/061; H04L 63/0414; H04L 2209/84
USPC 713/171

(57) ABSTRACT

A first aspect of the invention includes a method of securing messages using multiple cryptographic algorithms that distributes the burden of computing a session key using a strong cryptographic algorithm while using the session key with a faster cryptographic algorithm to protect messages long enough to compute a new session key. Some embodiments can be improved by use of a non-repeating seed, slotted storage of session keys, or both. A second aspect of the invention is generally directed to an augmented multi-stage hash function, which can be used as the faster cryptographic algorithm.

### BACKGROUND OF THE INVENTION

Many physical systems that were once isolated are transitioning to computerized networks; becoming cyber-physical systems. Many of these systems have real-time and safety requirements that preclude the use of traditional data security mechanisms. For example, some automobile systems have design requirements including a maximum or deterministic calculation time, encryption calculations that occur in microseconds on small 8-bit processors that operate at 10's of megahertz, robustness to dropped messages, do not use inter-message chaining, and retention of application layer validation.

Some automobile manufacturers have started including checksums, simple Cyclic Redundancy Checks (CRCs), or hashes inside CAN message data frames for certain messages in order to authenticate the message sender and ensure message integrity. Hashing in this manner can be insufficient against deliberate attacks. Additionally, the content of the message is openly available to an eavesdropper, thus allowing for interpretation of message meaning, which can result in the loss of proprietary or personal data. For example, the presence of GPS coordinates on a vehicle bus, when broadcast in plaintext can allow an intruder to listen on the bus to determine a person's location.

An additional protection mechanism, a count, is sometimes incorporated into the data frame. The count's purpose is to ensure chronological order and continuity of the messages. This counter can allow the detection of a device that has failed into an infinite looping condition, causing the rebroadcast of constant data yielding unsafe system operation. However, this count provides incremental change to an otherwise constant data frame, thus providing insight into any hashing algorithm employed. Due to real-time requirements and computational overhead, many algorithms used for authentication are vulnerable to attacks. Automobile electronic control systems can be made from a diversity of processor architectures and computational power. For example, the engine controller is often a device operating with a clock over 100 MHz and 32 bit instruction widths, while the fuel pump controller may operate at a few tens MHz with 8 bit instruction widths. This makes some authentication methods less useful because the implementation code is instruction width dependent forcing the explicit tailoring of the code to the specific processor, or computationally inefficient, resulting in increased integration difficulties specific to each controller.

At least two methods have been observed in OEM systems, simple checksums which involve looping through the data frame and adding the byte values together, and a CRC, which is computationally similar to a Pearson's hash when implemented with a lookup table. A Pearson's hash uses an exclusive OR logic operation (XOR) on each byte with the previous result, and uses the resulting value as an index into a table. The checksum has N+M cycles where N is the number of bytes and M is the loop overhead while the hash requires 3N+M cycles. These messages may be sent at frequencies up to 100 Hz, and several tens of messages may be present at any given time.

Once an authentication mechanism is understood, and the messages of interest are identified, it can be simple to create and send false information and even to send it in response to a desired set of conditions. Additionally, incorporating a hash into a data frame alone, despite the quality of the hashing algorithm, does not protect against playback attacks where bus activity is recorded during an event, and subsequently played back over the bus. For example, it may be possible to record the event of an airbag deployment and attempt to recreate that event on an unsuspecting party.

This type of insecurity of automotive networks may present significant liability to automotive manufacturers and their suppliers, not to mention the safety concerns for the occupants of a compromised vehicle. Illegitimate messages on these networks can effect operation of the brakes, engine, and steering systems. One type of vehicle network is a Controller Area Network (CAN) by which many real time command and control messages on the vehicle are transmitted. The CAN is a government mandated system that enables intra-vehicle communication and vehicle diagnostics.

CAN is expected to be a primary way of executing intra-vehicle communications for the foreseeable future. CAN is inherently insecure, there is no source authentication and the small data frame size and high frequency messaging prohibit standard authentication and encryption methodologies.

As noted above, manufacturers have recognized weaknesses of CAN and have begun to implement rudimentary authentication schemes in their high value messages. In many automotive systems, simple checksums, or XOR-ing of the data bytes is employed to prevent a malformed message from being acted upon by a receiving control module. A receiving module will calculate upon seven of the data bytes, and compare the result to what is received in the eighth data byte. If the bytes match it is assumed valid, otherwise the message is discarded. It is not thought that this operation was conceived as a security measure, because of the simplicity in identifying the methodology and defeating it, but rather as a rudimentary authentication measure. Some systems use additional measures such as abnormal carry operations or inclusion of an arbitration identifier in the validation calculation.

Some system designers have recognized the security aspects of such a validation byte, and have begun to employ high entropy calculation methods, such as a CRC and its derivatives. The inclusion of such techniques is a significant step forward in preventing an attacker from forming malicious messages and taking control of vehicle systems, but significant vulnerabilities remain. First, the Pearson's hash or CRC and derivatives are not cryptographically secure; statistical analysis and transition observations can expose the order of table members, allowing for the determination of the table to be made. Second, these measures do not protect against a playback attack. Often times a CAN reception handler stores only the ‘newest’ message in processing buffer for each arbitration identifier. Thus an attacker simply has to talk faster than a legitimate message, and vehicle operation can be modified. For a playback attack to occur, the attacker need only generate an event, such as antilock brake actuation or airbag deployment, and record the messages that occur. The messages can be rebroadcast against a target vehicle and will be valid with the proper hash, no matter how complex such a hash is.

A hash function is an algorithm that takes an arbitrary amount of data and encodes the data as a fixed-size bit string, referred to as the hash value, such that any (accidental or intentional) change to the data will likely change the hash value. The data to be encoded by the hash function is sometimes called the message, and the hash value is sometimes called the message digest or simply digest.

A hashing function can be used to determine a hash value for a plaintext message, such as a CAN bus message. The hash value can be appended to the plaintext message and transmitted to a receiver so that the receiver can use the hash value to verify that the plaintext message is authentic.

### SUMMARY OF THE INVENTION

A first aspect of the invention is generally directed to a method of securing messages in a real-time system using multiple cryptographic algorithms. The method distributes, across cycles of the real-time system, the burden of computing a session key using a strong cryptographic algorithm while using the session key with a faster cryptographic algorithm to protect messages long enough to compute a new session key. In some embodiments, the method is improved by use of a non-repeating seed, slotted storage of session keys, inclusion of a nonce value, or all of these.

The method of securing messages in a real-time system using multiple cryptographic algorithms generally includes periodically, at regular or irregular intervals, computing a session key using a first cryptographic algorithm, the first cryptographic algorithm having a computation cost greater than an available cryptography portion of a message computation cost and encoding messages with the session key using a second cryptographic algorithm, the second cryptographic algorithm having a computation cost equal to or less than the available cryptography portion of the message computation cost.

The method may include receiving a slot identifier, storing the computed session key in memory based on the slot identifier, and transmitting the encoded messages with the slot identifier so that the encoded messages can be decoded.

The method of securing messages may include obtaining a nonce value. The nonce value can be used by the second cryptographic algorithm to increase the number of messages capable of being encoded before a static message causes a repeated encoded message. The nonce value may be a part of the message being encoded or alternatively the nonce value may be a separate value that acts as a step-in value to the second cryptographic algorithm. The method may include selecting the size and interval of the nonce value to provide sufficient time for re-computing the session key using the first cryptographic algorithm across multiple cycles of a real-time system before a static message causes a repeated encoded message. The method may include receiving a slot identifier, storing the nonce value at an address in memory based on the slot identifier, and transmitting the encoded messages with the slot identifier.

The method may include pre-computing future session keys using the first cryptographic algorithm based on a predictable seed value. The seed value may be non-repeating.

The method may include periodically computing a session key within the break time of the second cryptographic algorithm.

A second aspect of the invention is generally directed to an augmented multi-stage hash function, which can be used as the faster cryptographic algorithm in the method of securing messages using multiple cryptographic algorithms. Additionally, a method of decoding a message encoded using the augmented multi-stage hashing function is provided. The augmented multi-stage hashing function produces two or more hash values that are protected by a dynamic key. The hash values correspond to portions of the message and can be decoded into the original message with the dynamic key and the reverse hashing algorithm. The augmented multi-stage hashing function can be utilized as the algorithm for encoding and decoding messages with the session key using a cryptographic algorithm having a calculation time equal to or less than the available cryptography portion of the maximum message time frame, discussed above.

A method of encoding a message using an augmented multi-stage hashing function can include obtaining a dynamic key, obfuscating the message with the dynamic key through a logic operation, and hashing the obfuscated message with a hashing function to obtain two or more hash values that correspond to portions of the obfuscated message.

A method of transmitting a message encoded using an augmented multi-stage hashing function and a method of receiving a message encoded using an augmented multi-stage hashing function are also provided. The method of transmitting can include forming a packet for transmission over a network, which can be independently decoded by a receiver. For example, the two or more hash values can be transmitted together in a packet to a receiver. The method of receiving can include receiving a packet encoded with an augmented multi-stage hashing function and using a key and an reverse look up table to decode the hash values into the original message.

In one embodiment, a transmitter and receiver can privately compute a dynamic key using a seed and a private algorithm known by both the transmitter and the receiver. The dynamic key can be of sufficient length to obfuscate the entire message. For example, a 64 bit dynamic key may be sufficient to obfuscate an 8 byte message through an exclusive OR logic operation. The key can be dynamic by changing as a function of the seed changing. The seed can be changed in response to an event or timer, such as at vehicle start-up or a 24 hour timer.

In one embodiment, a method of encoding a message using an augmented multi-stage hashing function can be implemented using an augmented iterative hash function. An iterative hash function generates two or more hash values that correspond to portions of the message where each hash value (except the first) is dependent on the previous hash values. Such a method includes obtaining a dynamic key, obfuscating the message with the dynamic key through a logic operation, and hashing the obfuscated message with an iterative hashing function to obtain two or more hash values that correspond to portions of the obfuscated message. An example of this includes indexing a hash table to determine a first intermediate hash value. The index to look up the first intermediate hash value is generated from a logical operation between a first portion of the message, a first portion of the dynamic key, and an initialization value. A second intermediate hash value can be generated by indexing the hash table. The index to look up the second intermediate hash value can be generated from a logical operation between a second portion of the message, a second portion of the dynamic key, and the first intermediate hash value. This can be repeated until a hash value is generated for each portion of the message. For example, an eight part CAN message can generate eight hash values.

A receiver can decode the hash values into the message by using the dynamic key computed from the seed, and a reverse-look up hash table. For example, the receiver can essentially reverse the process used to encode the message by indexing the reverse-look up table with the last hash value. The result of that look-up can be operated on by the corresponding portion of the dynamic key, and the next to the last hash value in order to decode the last portion of the message. This process can be repeated until each portion of the message is decoded.

In one embodiment, the method for encoding a message using an augmented multi-stage hashing function includes use of a modified Pearson hashing function for encoding a message for a real-time network, such as a Controller Area Network. In this embodiment, the first portion of the message, the first portion of the dynamic key, and an initialization byte are XORed to produce a first intermediate hash value. That is, the XORed value obfuscates the message and acts as an index to a hash table containing values used to generate a hash. The second portion of the message, the second portion of the dynamic key, and the first intermediate hash value can be XORed to generate a second intermediate hash value. This can be repeated until a hash value is generated for each portion of the message.

There are a number of benefits of combining a multi-stage hash function with a dynamic key. The computational overhead is small, the method is system independent, the method can be implemented in software without new hardware, the method is deterministic, the method can obscure the data, the method is resistant to playback attacks, the data packets can be independently validated (do not rely on past or future packets), and the combination of the two methods is more secure than the methods on their own.

Further, there are a number of benefits to the method of securing messages using multiple cryptographic algorithms. Many real-time systems have real-time constraints. This method can operate within the real-time constraint but still provide increased security.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows one embodiment of a method of encoding a message using an augmented multi-part hashing function.

FIG. 2 shows one embodiment of a method of encoding a message using an augmented multi-part hashing function.

FIG. 3 shows one embodiment of a method of encoding a message using an augmented multi-part hashing function.

FIG. 4 shows one embodiment of a method of decoding a message encoded using an augmented multi-part hashing function.

FIG. 5 shows one embodiment of a method of decoding a message encoded using an augmented multi-part hashing function.

FIG. 6 shows one embodiment of a method of decoding a message encoded using an augmented multi-part hashing function.

FIG. 7 shows exemplary packets where no validation byte is implemented.

FIG. 8 shows exemplary packets using a checksum validation byte.

FIG. 9 shows exemplary packets using a Pearson's Hash validation byte.

FIG. 10 shows exemplary packets generated using one embodiment of a method of encoding a message using an augmented multi-part hashing function.

FIG. 11 shows one embodiment of a flowchart for receiving and decoding an encrypted message.

FIG. 12 shows one embodiment of a flowchart for encoding and transmitting the encrypted message.

FIG. 13A shows one embodiment of a flowchart for a master processor to generate and broadcast seed and nonce messages.

FIG. 13B shows another embodiment of a flowchart for a master processor to generate and broadcast seed and nonce messages.

FIGS. 14A-C show three embodiments of network architecture for use with a method of securing messages.

FIG. 15 illustrates one embodiment of a method of securing messages in a real-time system having a maximum message time frame.

FIG. 16 illustrates the relative computation costs of two cryptographic algorithms and the message computation cost.

### DESCRIPTION OF THE CURRENT EMBODIMENTS

### I. Method of Securing Messages Using Multiple Cryptographic Algorithms

The method of securing messages in a real-time system using multiple cryptographic algorithms generally includes periodically, at regular or irregular intervals, computing a session key using a cryptographic algorithm having a computation cost greater than an available cryptography portion of a message computation cost and encoding messages with the session key using a cryptographic algorithm having a computation cost equal to or less than the available cryptography portion of the message computation cost. FIG. 16 illustrates one embodiment of relative computation costs. Computation costs may be in terms of cycles, time, or another resource.

Some real-time systems place a constraint on message computation cost. For example, some real-time systems define a maximum message transmission time frame, maximum message reception time frame, maximum number of message transmission cycles, maximum number of message reception cycles, or otherwise constrain the amount of resources available in connection with a message in a real-time system.

The formation of an encoded message using a cryptographic algorithm takes a certain amount of resources (i.e. time or cycles). The amount of resources is generally dependent upon the complexity of the cryptographic algorithm. Although high complexity cryptographic algorithms may provide desired security, they may exceed the amount of available resources in real-time systems. Low complexity cryptographic algorithms may be executed within the constrained amount of available resources, but may not provide the desired amount of security.

By periodically computing a session key with a high complexity cryptographic algorithm without regard to message computation cost constraints and protecting that session key with a low complexity cryptographic algorithm within computation cost constraints, the message computation cost constraints can be obeyed while simultaneously protecting messages for long enough to re-compute the session key. In some embodiments, the amount of time to break the low complexity cryptographic algorithm may be known or estimated and the system may be configured such that a new session key can be computed by the high complexity cryptographic algorithm within the break time of the low complexity cryptographic algorithm. Break time is generally defined as the amount of time, cycles, or other resource an observer would need to in order to obtain the underlying key and use it to generate messages which pass the verification mechanism.

For example, a cryptographic process takes time, Tₘ, which is dependent upon the complexity of the cryptographic algorithm, among other factors. In one embodiment, two algorithms, one of which has high complexity and thus long Tₘ is used to protect a private key over the life of a vehicle, while the second algorithm is low complexity with low Tₘ. The high Tₘ algorithm is computed once per session to generate a session key, and the computation can be distributed over the session by computing a portion of the algorithm in each cycle of the real-time system small enough to meet the real-time constraints of system, while the low Tm is incurred per message.

A real time system is one that deterministically executes a process within a maximal amount of time. The process may be a group of sub-processes in which each sub-process executes within its own maximum time limit. A real time system that receives and processes messages may have a maximum time for the message processing sub-process. Any operation, including cryptographic functions, must fit within that maximum time. A real time system can be viewed as operating on a schedule, and each operation must fit within their scheduled time period.

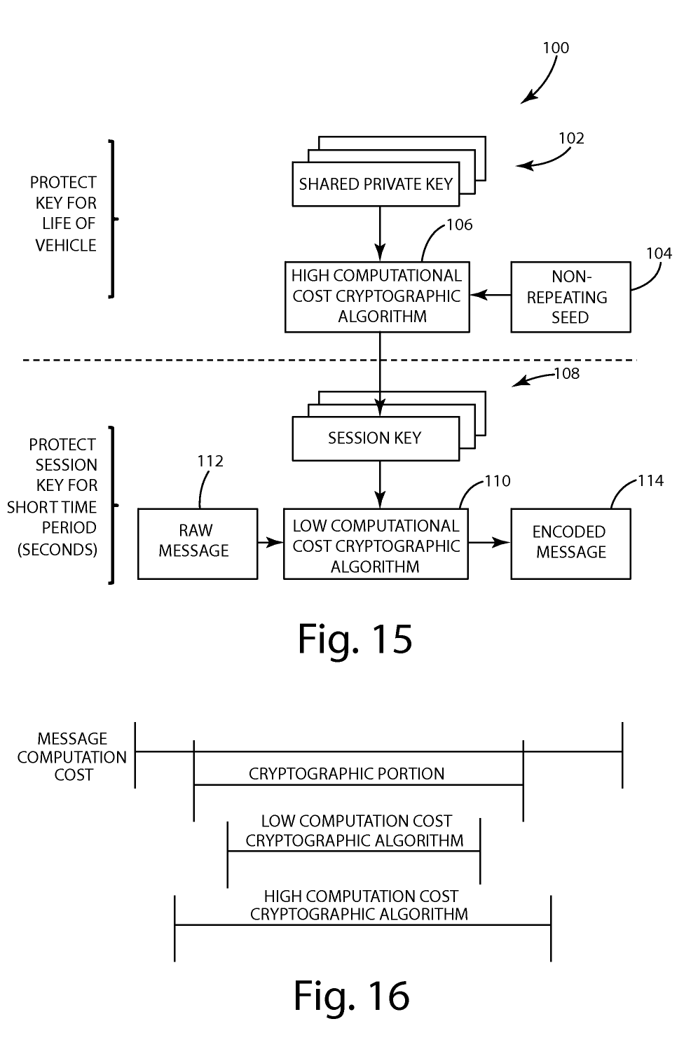

Referring to FIG. 15, different embodiments can change session keys at different periods. For example, in one embodiment, each module 100 computes one or more session keys once per system initialization (i.e. once per ignition cycle in a real-time system in a vehicle), and does not be recomputed the one or more session keys during operation. In another embodiment, each module 100 recomputes the one or more session keys on a frequent basis during operation. As will be discussed below, the low computational cost cryptographic algorithm may include additional features to excite the data payload enough to ensure that static message data produces encoded messages that are continually dynamic, sometimes referred to as non-repeating.

Typically, cryptographic algorithms for real-time systems are considered during hardware design, such that the desired algorithm may be computed within the real-time constraints of the system. The current embodiment of securing messages can be used to add encryption to a system which was not designed to handle the computational burden of a complex cryptographic algorithm.

In one embodiment, the method of securing messages in a real-time system using multiple cryptographic algorithms can be implemented as a low cost method for protecting CAN messages. In alternative embodiments, the method of securing messages can be used in different real-time systems. The various characteristics and nature of CAN messages make the method particularly suitable. CAN data generally are commands or measurements between devices that generate physical effects. An attacker seeks attainment of a specific physical effect; the data itself has little to no value. In contrast to traditional network security where data protection is paramount, in the CAN or real-time system scenario, encryption aims to protect against the ability to generate an inappropriate physical effect rather than protecting the underlying data. For example, breaking an encryption algorithm where the underlying data can no longer be used to create the same specific physical effect has few uses. Accordingly, use of a cryptographically weak algorithm is acceptable if the weak algorithm is re-keyed using a cryptographically strong algorithm faster than an attacker can obtain the key.

Referring to FIG. 15, an example is provided within the context of a vehicle using CAN. Modules throughout the vehicle have private keys 102 stored in memory that enable communication. Any module with a private key can encrypt and decrypt messages encrypted or decrypted by another module using the same private key. Some modules can have multiple private keys so that they can communicate with multiple modules. For example, a module may have multiple private keys and be capable of calculating multiple session keys from each private key. As an example, an engine control module and an anti-lock brake control module may have the same private key so that they are capable of transmitting/receiving messages. In addition, the engine control module and the ignition module may have the same private key that may be different from the key in the anti-lock brake control module so they are capable of transmitting/receiving messages. However, if the anti-lock brake control module and the ignition module do not have access to the same shared private key, they will not be able to encode/decode messages from each other. Alternatively, a module may be capable of calculating multiple concurrent session keys from the same private key by using a different algorithm of similar or same computational cost. In this situation, although modules share private keys, they can only communicate if they also have the same cryptographic algorithm.

Each module can obtain a seed value 104. In the current embodiment, the seed is an initialization value used to introduce entropy into the high complexity cryptographic algorithm. Each module can compute a session key using a high computational cost cryptographic algorithm 106, the private key 102 stored in memory, and the seed 104. This computation can be conducted periodically, at regular or irregular intervals. In the depicted embodiment, the session key is computed upon system initialization in each module. In alternative embodiments, the session key 108 can be periodically recomputed during operation or at other times.

In one embodiment, the seed provided to the modules 100 is a non-repeating seed. For example, the system may be configured such that no session key is computed using the same seed value twice. Use of a non-repeating seed can help prevent an attacker from transmitting a repeated seed to force transmitted data into a consistent pattern. In order to be non-repeating the size of the seed can be designed such that it will not roll over during practical use. For example, where the seed is calculated on system initialization, the seed generator may be capable of generating a number of different seeds greater than the number of expected initialization cycles of a system. Or where a new seed is calculated frequently during operation of a system, the seed generator may be capable of generating a number of seeds sufficient for the expected life of the system.

In one embodiment, the seed generator is a sequential counter and the modules include a filter that verifies the seed meets two criteria: it is not a previous value of the seed, and it is within a window of acceptable future values of the seed. A previous value may be used to make previously observed data valid, whereas a value too far ahead of the current value may be used to roll the counter over and use previous values. In one embodiment, for a vehicle with an expected typical number of initializations, a 64 bit counter can be a non-repeating seed because it has 1.8×10¹⁹ possible values, so even a reasonably large window of acceptable seeds may be used and attacked (by repeatedly being forced to the end of the window) without rolling the seed counter in the life of the vehicle. Alternatively, a pseudo-random number generator or other method may be used instead of a sequential counter, so long as the sequence is predictable in a way that it can be verified using the above criteria.

In one embodiment, the seed generator generates a predictable seed. In addition to allowing verification that a seed has not been previously used, a predictable seed enables pre-computing of future session keys with spare resources. For example, there may not be time for a session key to be computed within message computation cost constraints of a real-time system, however, processors need not wait until they receive a seed to begin calculating a future session. By pre-computing session keys, real time system resources can be used more efficiently.

Returning to FIG. 15, a valid seed 104, combined with the private key 102, can be put through a cryptographic algorithm 106, such as a hashing algorithm, to produce a session key 108. In an alternative embodiment, a public key infrastructure may be used to authenticate and then transfer a corresponding session key.

In operation, a transmitting module encodes a raw message 112 using the session key 108 and a low computational cost cryptographic algorithm 110. This encoded message 114 can be transmitted, for example it may be transmitted to an address or broadcast on the CAN bus with an arbitration identifier. Upon receipt of the encoded message, the message can be decoded using the low computation cost cryptographic algorithm and the same session key that was used for to encode the message. In this embodiment, modules that have the same private key, and hence the same session key, can decode the encoded message.

One advantage of this method of using multiple cryptographic algorithms may be better understood by way of an example using a vehicle that communicates via CAN. Any module that would like to send a message on the CAN bus can do so by preparing a CAN message, which can be referred to as a raw message. Many systems using CAN have real-time constraints for transmitting messages. For example, in this embodiment, a system using CAN may have a maximum or deterministic message time frame, which is an example of a message computation cost constraint. This is the total amount of time that the module has to form the raw message, add the header, execute any cryptographic algorithm, put the message on the CAN bus, and conduct any other message processing. The method of securing messaging using multiple cryptographic algorithms is particularly suited to addressing this type of real-time system constraint because a deterministic low computation cost cryptographic algorithm can be selected to ensure that message to message operation is within the maximum message time frame, while still providing security above and beyond that offered by the low computation cost cryptographic algorithm because of the high computational cost cryptographic algorithm that generates the session keys and the limited temporal usage of each session key.

The high computation cost cryptographic algorithm and the low computation cost cryptographic algorithm can be essentially any cryptographic algorithms that have the appropriate computation costs. The high computation cost cryptographic algorithm has a computation cost greater than the available cryptography portion of the message computation cost. Put another way, the computation cost of the high computation cost cryptographic algorithm together with the other message computation costs exceeds the total message computation cost constraint, while the computation cost of the low computation cost cryptographic algorithm together with the other message computation costs does not exceed the total message computation cost constraint. The specific amount of computation costs for the low and high cryptography algorithms can vary depending on the application and the specific message computation cost constraint.

In one embodiment, the session key can be dynamically changed during operation to ensure that identical messages with underlying content do not result in the same encoded message. This method can be implemented using the augmented multi-stage hash function described below or another encryption algorithms such as those of the Simon and Speck Families or the widely adopted AES schemes. When combined with the augmented multi-stage hash function, an extremely computationally efficient means of protecting data is available which respects the constraints of real-time cyber-physical systems, a prominent example being automobiles. Performing traditional encryption (such as AES) on these networks is not currently possible given the computational and time constraints of present day automotive electronics.

A specific example of an improved method of securing messages using multiple cryptographic algorithms is provided below within the context of a CAN system of an automobile. A controller area network is one of the most common automobile networks. It broadcasts messages with an arbitration identifier reflecting message contents and priority, and zero to eight bytes of data. The standard also incorporates a start of frame, control field, CRC field, ACK field, and an end of frame indicator; however these elements are not typically made available to or used by the application software. An exemplary CAN frame is shown in Table 1.

TABLE 1

| | | | | | | | | |
|---|---|---|---|---|---|---|---|---|
| Arbitration | Data 0 | Data 1 | Data 2 | Data 3 | Data 4 | Data 5 | Data 6 | Data 7 |
| ID | | | | | | | | |

Any device on the network can receive a broadcast message; likewise, since there is no inherent source authentication, any device on the network can broadcast any message. Safety enhancements may be incorporated within the application layer of the CAN communications to remediate the lack of control over transmission and reception of messages. Enhancements include the addition of a count, sometimes referred to as a nonce, and a validation byte, with the count oftentimes consisting of 4 bits in the Data 0 location and the validation being 8 bits in the Data 7 location. The validation byte has been observed in practice to be formed using simple checksums and CRC-8s. The incorporation of a count allows a receiver to verify that the transmitting device is generating new messages, even if the underlying content is the same. Incorporation of the validation byte ensures that the data within the packet hasn't changed (which is redundant with the CRC incorporated into the CAN protocol) and that the sender knows and has applied the proper mathematical operation to the underlying data. Applying this safety enhancement consumes 12 bits of the 64 bits available to the message frame.

TABLE 2

| Arbitration | | | | | | | | |
|---|---|---|---|---|---|---|---|---|
| ID | Data 0 | Data 1 | Data 2 | Data 3 | Data 4 | Data 5 | Data 6 | Data 7 |
| Funct. Msg | (x, Count) | x | x | x | x | x | x | Validation |

One way of attacking a CAN based vehicle involves analyzing existing messages and rebroadcasting specific functional messages at a dangerous or inopportune time. The method of securing messages using multiple cryptographic algorithms discussed above and the augmented multi-stage hashing function discussed below are ways to remediate the rebroadcasting of messages; by applying a dynamic key, which would be generated with a dynamic seed exchanged at the start of a session, such as when the vehicle is started or periodically in operation. The dynamic session key, when applied with an obfuscation algorithm tailored to the eight byte CAN data frame with a count and validation byte, causes the rebroadcast of data using a different key to be discarded. Additionally, the obfuscation makes the analysis of messages more difficult for an attacker, as the underlying data is not plainly visible. Each byte transmitted is the result of a previous calculation and an operation with the key.

TABLE 3

| Arb. ID | Data 0 | Data 1 | Data 2 | Data 3 | Data 4 | Data 5 | Data 6 | Data 7 |
|---|---|---|---|---|---|---|---|---|
| Functional | f(x, Count) | f(x, | f(x, | f(x, | f(x, | f(x, | f(x, | Validation |
| Msg | | Data | Data | Data | Data | Data | Data | |
| | | 0) | 1) | 2) | 3) | 4) | 5) | |

The algorithm can be designed to minimize the computational cost, maintain deterministic operation, consume only the 12 bits already consumed by the safety enhancements already used in practice, and retain the inherent CRC validation of the message contents.

If the same message is repeated and a 4 bit counter (nonce) is used, the obscured message data will be the same every 16 transmissions of the same underlying data. An attacker could use this repetition as an entryway to discovering the key used to encode the message. If the duration with which the key is valid is long enough for the key to be recovered, an attacker may be able to break the faster cryptographic algorithm.

Although changing the key upon ignition cycle provides a certain amount of security, it may be possible to increase security by changing the session key more frequently (i.e. during operation, not just upon system initialization), increasing the amount of time before static data produces a repeat encoded message, or both.

The calculation of a session key from a transferred seed can be a lengthy process on low power processors; therefore the session key change can be configured to occur as frequently as necessary to protect the underlying effect of the data. To achieve this, in one embodiment, an additional nonce value, 8 bits in this case, but may be of a different size, can be used alone or in conjunction with the first nonce, referred to as a count in CAN parlance. This value can be transferred within the payload of another message referred to as a nonce message. By using the 4 bit count nonce in the message and the 8 bit nonce from the separate nonce message, a total of 4096 messages can be transferred before having a repeat message and therefore before having to change session keys. For a message transferred at 100 Hz, a new key would be calculated from a seed in approximately 40 second intervals. This provides up to about 40 seconds to complete the computation of the high complexity cryptographic algorithm.

One issue that can arise when changing session keys and/or nonces during operation is lost messages. If a message is encoded using a session key and/or nonce, and then the session key and/or nonce value is updated, the message will no longer be able to be decoded and may be effectively lost. In one embodiment, one or more previous session keys and/or nonces are stored in memory so that messages encoded using a previous session key and/or nonce can be decoded. To decrease message loss during change of the session key and/or nonce value, multiple session keys and nonce values can be stored in memory and a slot selection identifier can be used to identify the appropriate session key and/or nonce value.

In one embodiment implemented in a CAN system, the least significant bit of the arbitration ID is implemented as a slot selection identifier to signify the nonce value used. In this way, one bit of the transferred message is used to indicate both the nonce and session key used to encode said message. Alternatively, if the implementer does not need strict deterministic operation, the signaling on the arbitration ID can be exchanged for a potential double calculation, where the expected answer is tried first, and if that count/key combination does not provide a valid result, then the second count/key combination is tested. The preceding method can be predictably bounded, much like a cache miss in a micro-processor.

TABLE 4

| Arbitration | | | | | | | | |
|---|---|---|---|---|---|---|---|---|
| ID | Data 0 | Data 1 | Data 2 | Data 3 | Data 4 | Data 5 | Data 6 | Data 7 |
| Seed Msg | Seed 0 | Seed 1 | Seed 2 | Seed 3 | Seed 4 | Seed 5 | Seed 6 | Seed 7 |
| Nonce Msg | Nonce | | | | | | | |
| Funct. Msg | f(x, Nonce) | f(x, | f(x, | f(x, | f(x, | f(x, | f(x, | Validation |
| | | Data | Data | Data | Data | Data | Data | |
| | | 0) | 1) | 2) | 3) | 4) | 5) | |

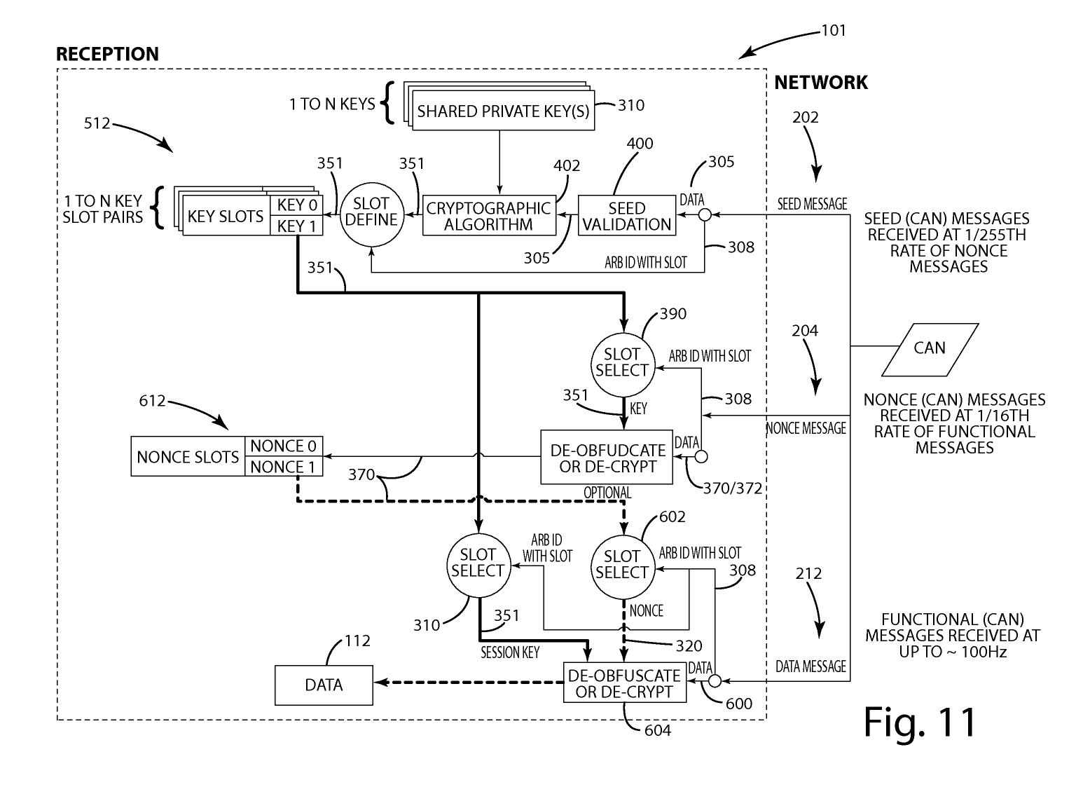

FIGS. 11-14 illustrate one embodiment of a method of securing messages using multiple cryptographic algorithms applied to a CAN bus with a fastest message transmission of 100 Hz. In alternative embodiments, systems may transmit slower or faster, and the respective timing of the system elements modified accordingly. The illustrated embodiment includes both a nonce in the message data a nonce (or additional counter) value updated approximately every 0.16 seconds which is used as a step-in value to the lookup table used in the obfuscation, and a new seed/session key computation approximately every 40 seconds (actual nonce update and re-seed intervals can depend on the rate of the fastest message). This embodiment caters the nonce and session key update times to the rate of the fastest message in order to ensure static data does not produce repeated messages.

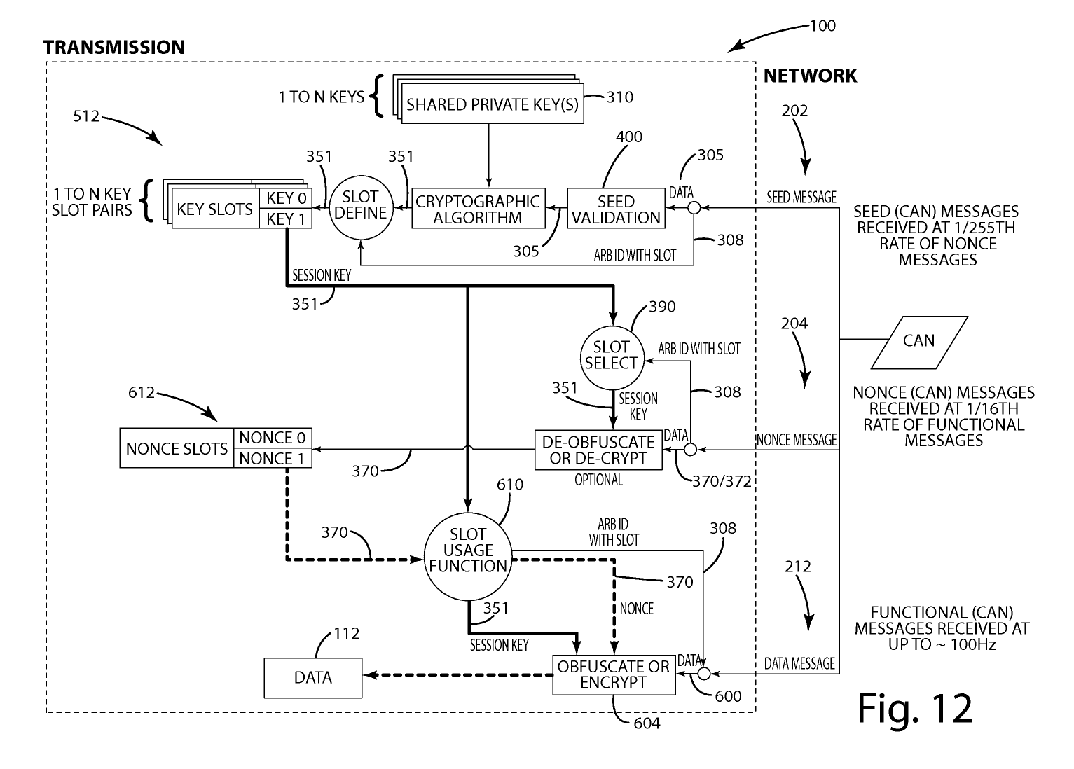

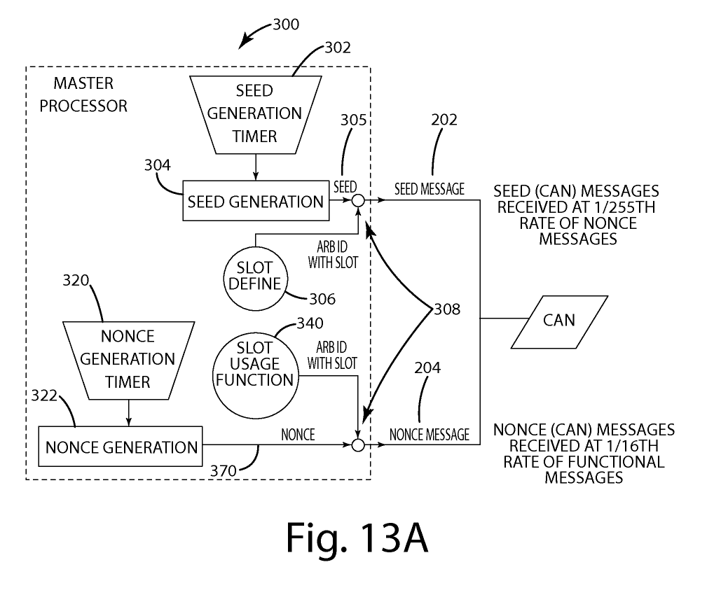

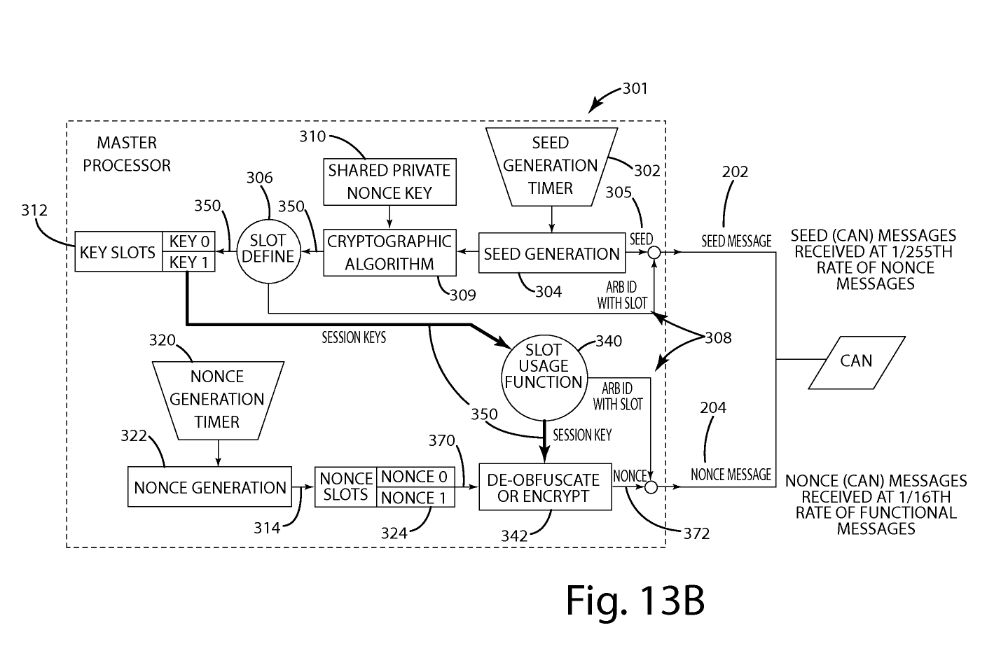

FIG. 12 illustrates a functional diagram of a module 100 encoding a raw message 112 and transmitting an encoded message 212. FIG. 11 illustrates a functional diagram of a module 101 receiving an encoded message 212 and decoding it back into the raw message 112. FIG. 13A illustrates one embodiment of a master module 300 for seed generation and nonce generation without obfuscation or encryption. FIG. 13B illustrates one embodiment of a master module 301 for seed generation and nonce generation including obfuscation or encryption. The exemplary modules 100, 101, 300, 301 may include one or more processors or other circuitry that implement the functional processes described herein. Although the description and diagram references CAN messages, this implementation is exemplary and may be implemented within the context of other real-time systems.

The master module 300 or 301 periodically generates and transmits a seed message 202 and a nonce message 204 for use throughout the system. The two embodiments of the master module 300, 301 will be described in more detail. Each module includes a seed generation timer 302 that generates a seed periodically. For example the seed generation timer 302 may be a 40 second timer. The seed generation timer activates the seed generation unit 304, which generates an actual seed value. In the current embodiment, the seed value is a sequential 8 bit counter value that increments by one each time a new seed value is generated.

The slot define unit 306 generates a slot identifier 308. The slot identifier 308 is used to identify the designated slot in memory where the seed in the seed message should be stored in the module that receives the seed message so that both the transmitting module and the receiving module can utilize the same key. In one embodiment, the slot define unit 306 alternates between a 0 slot identifier and a 1 slot identifier. In alternative embodiments, the slot define unit may alternate between different and/or additional values. In the current embodiment the slot define unit 306 uses the least significant bit of an arbitration ID as the slot identifier 308. The arbitration ID is used in traditional CAN systems to determine message priority and message address. In the FIGS. 13A and 13B embodiments, the seed value produced by the seed generation unit 304 is packaged into a seed message 202 with an arbitration ID where the least significant bit of the arbitration ID is the slot identifier 308 generated by the slot define unit 306. In alternative embodiments, CAN or otherwise, the slot identifier 308 may be separate from the arbitration ID.

In the FIG. 13B embodiment, which includes obfuscation or encryption of the nonce, the seed generation unit 304 also provides the seed to a cryptographic algorithm 309 for obfuscation or encryption. In the current embodiment, the cryptographic algorithm 309 encrypts or obfuscates the seed using a shared private nonce key 310 to generate a nonce session key 350. The nonce session key 350 is stored in the appropriate slot in memory 312 according to the slot identifier 308 generated by the slot define unit 306.

The master modules 300, 301 each include a nonce generation timer 320, which can operate similar to the seed generation timer—periodically providing an instruction to the nonce generation unit 322 to generate a nonce value 314. The nonce value 314 can be stored in one of the nonce slots in memory 324.

Whenever a new seed is transmitted by the master processor, the Slot Define unit 306 can chooses the oldest slot and transmits the seed with the signal for over-writing that oldest slot. The nonce messages are then generated and signaled to relate to a slot by the Slot Usage Function 340. Two embodiments of the Slot Usage Function 340 are described. In the first embodiment, the Slot Usage Function 340 signals the next nonce generated is transmitted on the newest slot, relating itself to the session key derived from the seed just transmitted. Under this embodiment, the new session key begins to be used immediately after broadcast. In the second embodiment, the Slot Usage Function 340 continues to signal the nonce usage on a slot containing an older session key until some later time. This later time could be set based upon the maximum expected cryptographic computation time of the session key from the seed for the entire system, or based upon some external stimulus. In short, under the second embodiment, the new session key is not used until some other trigger initiates its use, such as a timer or external stimulus.

Referring to the FIG. 13A embodiment, the slot usage function 340 provides the appropriate arbitration ID with slot identifier 308 for use in forming the nonce message 204. The nonce message payload includes the nonce value 324 and the nonce message header includes the arbitration ID, which includes the slot identifier 308. The FIG. 13B embodiment works similar to the FIG. 13A embodiment, except that the nonce value is obfuscated or encrypted using a cryptographic function 342. In the depicted embodiment, the slot usage function 340 obtains the appropriate nonce session key and uses it to encrypt the nonce session key. The encrypted nonce forms the payload of the nonce message 204 and the slot identifier 308 from which the slot usage function 340 obtained the nonce session key is used as the least significant bit in the arbitration ID of the nonce message 204.

In the current embodiment, inside the message content of all CAN messages there is a rolling 4-bit counter. Such a counter is often already implemented in automotive messages as a form of validation. The method uses such a counter to gain an additional benefit; to excite static data. Each change of the counter causes each message to produce a unique encoding for transmission, but if data remains static for sixteen messages and the counter rolls over, then the encoded message will repeat itself when the counter repeats. To address the repetition of static data, the illustrated embodiment adds a nonce value of one byte which is updated once every sixteen (or fewer) messages, and is used as a step-in value to the lookup table of the faster cryptographic algorithm. Thus, the path through the lookup table is augmented before the rolling counter repeats itself, ensuring that static data does not produce repeated messages.

In addition to changing the step-in (nonce) value to the lookup table prior to the counter rolling over, a new seed is broadcast and all electronic control units (ECUs) on the bus use the seed to compute a new session key before the nonce value repeats itself. For messages transmitting at 100 Hz using a 4 bit rolling counter inside the message, the new session key should be in effect every 40 seconds. The nonce value is one byte, which may cycle through 256 possible values before the session key is changed. The session key is computed using a cryptographic hashing algorithm and a private key and is used to encode and decode the data. Note that by supplying different modules with different sets of private keys, messages may be properly encoded or decoded only by modules with the matching private key. In this way, different modules may be “authorized” to only communicate with a subset of other modules on the same bus.

Since each ECU uses the same session key and nonce as the transmitter to properly decode the message, one bit of the arbitration identifier is used to indicate which nonce was used to encode the data. All controllers store the current session key, previous session key, current nonce, and the previous nonce. The least significant bit of the arbitration ID on the transmitted data message is toggled upon encoding with a new nonce. As new seed and nonce messages are broadcast, the key and nonce storage slots in each controller are overwritten first-in-first-out (FIFO). The newest and previous nonce and keys can be stored to handle the transition when changing encoding. Some controllers are slower than others and may transmit a message or decode a message from a buffer using the previous nonce or session key after the new nonce or key has been sent. Always storing the previous value allows for these messages to be decoded deterministically and ensures no message loss.

In the current embodiment, encoding data for transmission involves several pieces of information: a private key, a seed, a nonce, and any other items for the cryptographic algorithms, such as a lookup table if using the augmented multi-stage hash function. The seed and nonce are obtained from broadcast messages on the bus. The seed message is a simple 64 bit counter transmitted by the master ECU. When a seed message is received, it may be verified to ensure it meets two criteria: it is not a previous value of the counter, and it is within a window of acceptable future values of the counter, as discussed herein. A valid seed, combined with the shared private key, is put through a cryptographic algorithm to produce a session key.

The nonce value is also obtained from a broadcast message. The broadcast message may optionally be obfuscated or encrypted without the use of a nonce step-in value; in either case, in the current embodiment, the least significant bit of the Arbitration ID is used as a slot selection identifier to indicate the associated seed. Each data message is associated with a nonce slot as indicated by the least significant bit of the Arbitration ID, and each nonce message is associated with a session key slot as indicated by the least significant bit of the Arbitration ID of the nonce message. This scheme sacrifices only one bit of data per message to unambiguously indicate the specific nonce and session key used to encode the data. In the nonce message, only one byte of the data is needed to be the nonce, thus the remainder of the message may optionally contain some other data, or may contain unused random values as is done in the reference implementation.

The transmitter of a data message will select an Arbitration ID whose least significant bit reflects the slot of the most recently received nonce. Note that an optional period of latency may be implemented after receiving the most recent nonce and beginning to use the most recent nonce. Using that nonce, and the key associated with that nonce, the transmitter may encode the data and send it out on the bus.

Hence the arbitration ID is used to signal which key/nonce slot is to be used, preserving the message content available. Such a system reduces the range of arbitration IDs available by a factor of two. As the arbitration identifier is 11 bits or 29 bits for some CAN 2.0 implementations, thus 2¹⁰ or 2²⁸ values are still available respectively, which is sufficient for automotive applications. Alternate embodiments may use any available bit as the slot selection identifier, and are not limited to using the least significant bit of the arbitration ID.

FIGS. 11 and 12 illustrate functional diagrams of reception and transmission, respectively. In both situations, in the depicted embodiment, two messages are transmitted on the network for operation, the seed message 202 and the nonce message 204. These messages are handled identically by a module that wants to transmit a module and a module that wants to receive a message. That is, the modules on the network receive and process the seed message and the nonce message so that they can effectively encode and/or decode messages. The seed message 202 includes a seed value 305 in the payload and an arbitration ID with a slot identifier 308 in the header. The nonce message 204 includes a nonce value 370 or encrypted nonce value 372 in the payload and an arbitration ID with a slot identifier 308 in the header. Because seed messages and nonce messages are not necessarily sent at the same rate or at the same time, the value of the slot identifier 308 of the seed message 202 and the value of the slot identifier 308 of the nonce message 204 may be different.

In response to receiving a seed message, as shown in FIGS. 11 and 12, the seed value 305 can be validated with a seed validation process 400. For example, the seed validation process may verify the seed is not a previous value of the seed, and it is within a window of acceptable future values of the seed. The verified seed 305 is used to generate a session key 351 through a cryptographically secure algorithm 402 by way of one of a plurality of private keys 310, e.g. SHA-256 hashing, or a public-key exchange. When a new session key 351 arrives it replaces the oldest session key in one of the session key slots in memory 512. The slot define process 306 defines the slot in memory 512 where the session key should be stored based on the slot identifier 308. The nonce message 204

In response to receiving a nonce message, as shown in FIGS. 11 and 12, the nonce value 370 can be stored in memory 612 based on the slot identifier 308 of the nonce message. In embodiments where an encrypted nonce value 372 is provided, the slot identifier 308 can be used by a slot select process 390 to select the appropriate session key 351 out of memory 512 that was used to encrypt the nonce value. That session key 351 can be used to de-obfuscate or decrypt the encrypted nonce value 372. Once decrypted, the unencrypted nonce value can be stored in memory 612 based on the slot identifier 308 accompanying the nonce message.

The seed value and nonce values can be broadcast periodically to support modules resetting and/or message loss and updates at a predefined time. The nonce message associates itself with a particular session key slot and can be optionally run through the block cipher. The presence of the nonce stretches the time before a key expires by applying an additional eight bits of count space, resulting in a 12 bit counter exciting the message content. The extra eight bits also allows the session key size to be extended to 72 bits. To prevent retransmission of the same message containing the same data, the key can be changed prior to the 12 bit count rolling over. Automotive environments are hard real-time systems and programmers should account for the rollover time during design. The device responsible for seeding updates the seed at a predefined interval and modules begin using the new key to form messages while still using the old key for preexisting messages. Note that an optional latency period may be implemented after receiving the most recent seed and beginning to encode messages using the session key calculated using said seed. At the message reception level, the operation is the same, except that an additional byte, the nonce, is applied to the block cipher chain, and the key applied to that chain comes from an array access instead of a simple variable access.

The encoding process illustrated in FIG. 12 and the decoding process illustrated in FIG. 11 will now be described in more detail.

Referring to FIG. 12, the process for encoding data 112 and transmitting the data in a data message 212 includes obtaining the appropriate nonce value 370 from memory 612 and session key value 351 from memory 512. The appropriate values are obtained by the slot usage function, which knows the current slot identifier for the key slot in memory 512 and the current slot identifier 308 for the nonce slot in memory 612. Using the session key 351 and the nonce value 370, the augmented multi-stage hash function described in more detail below or alternatively, a peer reviewed encryption algorithm, the transmitter can encode the data 112 into encoded data 600. The encoded data 600 can form the payload of a data message 212 while the arbitration ID can be included in the header of the data message 212 with the least significant bit of the arbitration ID as the slot identifier 308, which indicates which session key and nonce value were used to encode the message.

Referring to FIG. 11, the process for receiving a data message with encoded data 600 and decoding the encoded data 600 into the original raw message 112 is provided. In response to receiving the data message 212, the slot identifier 308 is used to select the appropriate session key 351 from memory 512 using the slot select process 390 and nonce value 370 from memory 612 using the slot select process 602. The nonce value 370 and session key 351 can be used to de-obfuscate or de-crypt the encoded data 600 back into the original data 112.

The illustrated embodiment includes at least one designated master processor per bus which is responsible for transmitting seed and nonce messages. Seed messages may be sent in plain text. In the current embodiment, the nonce messages may be encrypted before being sent. In the current embodiment, a dedicated controller is provided, but in alternative embodiments any controller with the additional processing power to run the seed counter, nonce generator, and able to regularly send and receive a few extra messages could be used. FIG. 13 illustrates a functional flowchart of a master processor or ECU.

To be robust to injected traffic, if the master processor receives a seed or nonce message (which should never happen) that would be accepted by the required criteria, then it shall adjust its subsequent seed and/or nonce messages to continue from that new value. It is desirable, upon such an event, to log information about the occurrence and set an error. Alternatively, the master could force the entire network to operate in a limp mode which would protect the system from the attack at the cost of limiting the functionality of the system. The master processor has the responsibility of generating and transmitting seeds and nonce messages to the bus, but also computes and stores keys and nonce values as would a networked ECU in the case that the master is not a dedicated entity, but also sends and receives traffic as would any other module or device.

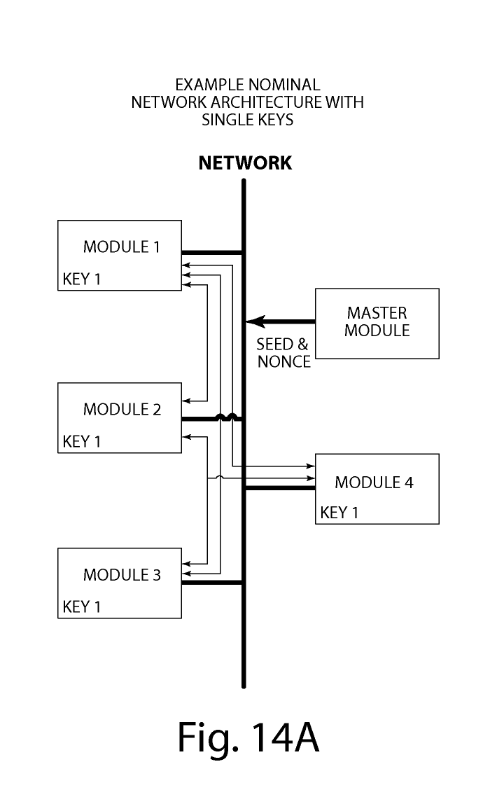

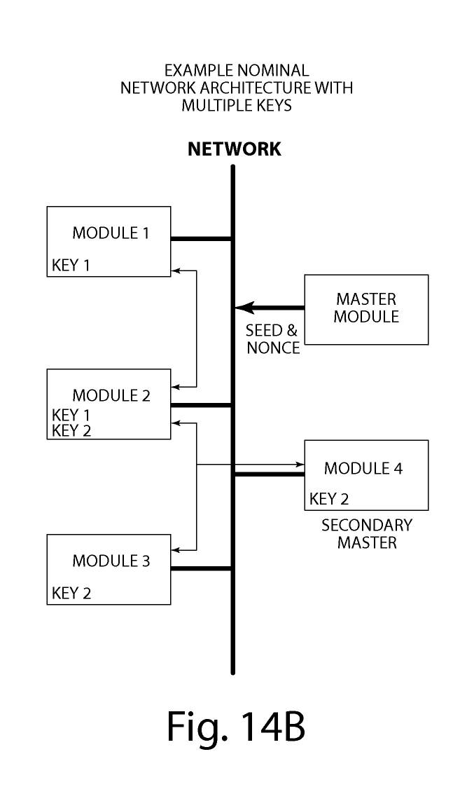

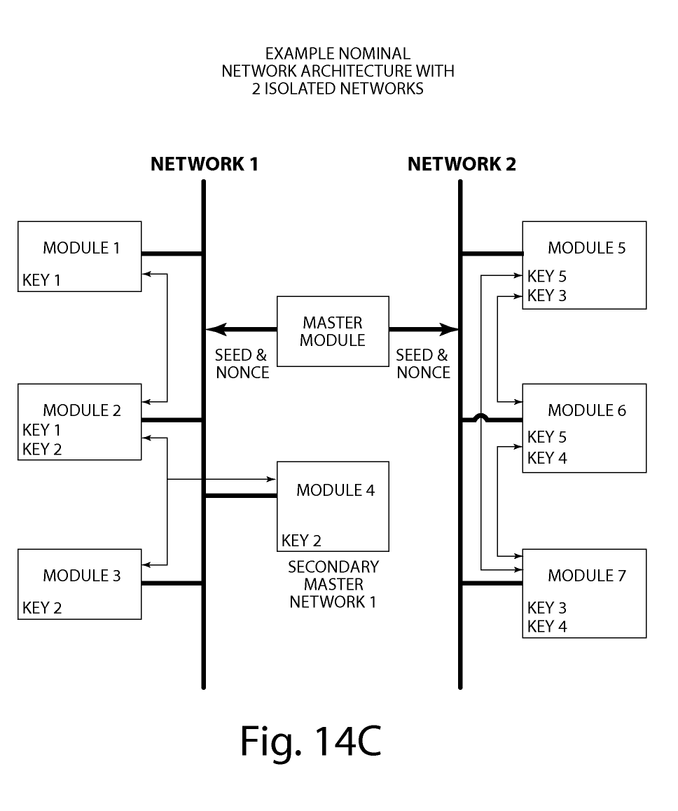

Many systems also need to be robust to the loss of a controller from the system. A secondary or backup master ECU may be used to ensure that, in the event the master ECU is disconnected or otherwise not communicating, the system does not need to resort to a limp mode. The secondary master would be programmed with the algorithm functionality of the master, but would only take the roll of the master upon detecting the loss of the master ECU. FIG. 14 shows this sort of arrangement in an example network architecture. The master may supply the seed and nonce messages to multiple buses and does not need knowledge of the private keys used to encode communications on the bus. Secondary masters may be present on each bus to continue the required broadcasts in the event of the master failing to transmit.

FIGS. 14A-C illustrate various network architectures for use with the methods described herein. The thin arrows show which modules can speak to which other modules (by nature of having a shared private key or having undergone a public key exchange), though all communication occurs over the bus. As can be seen, the same seed and nonce values can be used for any number of keys. Session keys are derived from the seed and the private key. FIG. 14A illustrates an example of a network architecture with one CAN bus where all communication occurs using a single private key to encode and decode messages. FIG. 14B illustrates an example of a network architecture with one CAN bus and the use of multiple private keys to create messages only decodable by authorized modules with the same private key. FIG. 14C illustrates an example of a network architecture with two physically separate CAN buses and the use of separate private keys to create messages only decodable by authorized modules with the same private key. Referring to FIG. 14A-C, the master module has no need to contain private keys used by other modules. Of course, it may have access to one or more private keys for its own functional messages.

### II. Augmented Multi-Stage Hash Function

A second aspect of the invention is generally directed to a method of encoding a message using an augmented multi-stage hashing function. One embodiment of the method of encoding can be done with a computational cost equal to or less than an available cryptography portion of a message computation cost and therefore can be used in concert with the first aspect of the invention. Although the augmented multi-stage hashing function can be utilized as the low cryptographic cost algorithm in the first aspect, it may also be implemented separately as a stand-alone cryptographic algorithm, not in connection with the first aspect of the invention.

Although not limited to use in a CAN system, the method of using an augmented multi-stage hashing function can be particularly suitable for a CAN system because it addresses two primary drawbacks of CAN application layer validation. First, it further abstracts the validation calculation by applying high entropy to every byte of transmitted data. In this method, data is not sent as raw bytes, but rather, a symmetrical block cipher chaining each value within a single message is performed prior to transmission and at reception. An attacker is presented with (256−1)! possibilities for the cipher table with a further multiplier of eight for determining which byte is the validation byte. By obscuring which byte holds the validation byte, transitional observations can be prevented outright (e.g. unlocking doors). By incorporating the CAN count into the message, every message byte exhibits high entropy even for the case where all underlying data is static. Secondly, it can prevent playback attacks from one CAN system or vehicle to another and one ignition cycle to the other. It does this by dynamically keying the algorithm. A seed can be broadcast onto the CAN bus at ignition. Each control module can use that seed to calculate a key. The key can then be applied as a modification to the block cipher. For an attacker to obtain the plaintext message or transmit a malicious message, he would need to first recover the cipher block and the dynamic key. For a 64 bit dynamic key, when an improper key is used on a message, it will not validate with 255/256 probability, and the data contained within will be invalid as well. Employing this methodology prevents simple CAN attacks where the attacker simply excites the system, records the reaction, and replays it at a different time. The augmented multi-stage hash function can be implemented using a function call before the CAN transmission function and in the CAN reception handler.

If implemented in a controller area network, this method may retain the following characteristics of the application layer validation: deterministic execution, occupation of a single byte in the data frame, high entropy validation and single bit dependency, register size independence, and independence between data frames. The method does not need to use conditional statements allowing calculation time to be precisely modeled for run-time execution modeling. No message data is required over that already being consumed by current practices. Finally, the algorithm uses no shifts, rotates or additions which may be register size dependent. Thus, a programmer can employ the same C code (or any other language) or auto-generated code on any processor that may be in the vehicle. Further, no message is dependent upon a previous or future message.

A method of encoding a message using an augmented multi-stage hashing function will be described in more detail now. The method can be used to validate and obfuscate messages. A multi-stage or intermediate hashing function refers to a hashing function that involves multiple hash table looks ups based on different portions of the message. Essentially any message can be encoded using this method. Messages that have a short frame and are transmitted over a low latency network, such as Controller Area Network (CAN) messages, may be particularly suited for this encoding method.

Also provided is a method of transmitting a data packet having a message encoded by an augmented intermediate or multi-stage hashing function, and a method of receiving and decoding a message encoded by an augmented intermediate or multi-stage hashing function. The method of transmitting can include forming a packet that includes intermediate hash values where each of the intermediate hash values correspond to a portion of the message (instead of the original message content). The method of transmitting can further include protecting the intermediate hash values with a key and transmitting the packet to a receiver for decoding. The method of receiving can include obtaining the key, receiving a packet with a message encoded by an augmented multi-stage hash function, and decoding the intermediate hash values into the original message using the key and an reverse look up table.

During application of a multi-stage hash function, an additional logic operation with each portion of the message being encoded is conducted with a key (either before or after the hash table look-up). For example, each byte of an 8 byte CAN message may be XORed with a byte from an 8 byte key resulting in 64 bit computational complexity to determine the proper hash. A CAN message may include 7 data bytes and one validation byte. The key can protect the data for a typical usage cycle of a vehicle. The method of encoding can include a key exchange that can take place periodically, such as on engine start.

The method of encoding a message with an augmented multi-stage hashing function can include obfuscating the data at little to no additional computational complexity. For example, where a validation value is being computed for a CAN message, the data can be obfuscated at little to no additional computational complexity. Instead of generating a single hash value and appending that value to a plain text version of the message being validated, the intermediate values of the hashing algorithm can replace the message to be sent. A reverse look up table allows for the operations to be undone to retrieve the original message, again, without added computational complexity. Augmenting a multi-stage hash function with a key prevents the direct observation of linkages within the look up table and enhances the viability of using intermediate result transmission as an obfuscation method.

The methods may include some event or time based dynamic key updates, and an additional eight operations per message resulting in a big 0 notation value of 4N+M. The combination of these techniques enhances protection against replay attacks, obfuscate message data from anyone sniffing the network, and enable the sender of a message to be authenticated in a robust, low cost, platform independent manner.

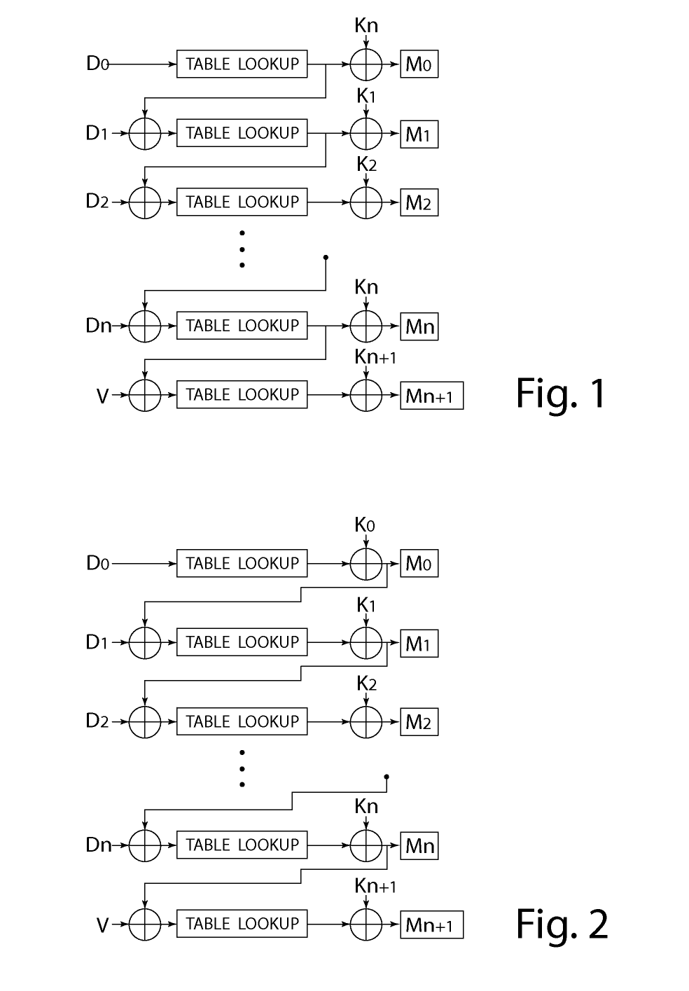

FIGS. 1-3 illustrate three embodiments of a method of encoding a message using an intermediate or multi-stage hashing function. The method also includes calculation of a validation value, V. The message or data being encoded can be split into multiple parts, illustrated as D₀-Dₙ in FIGS. 1-3. In the illustrated embodiments each part of the message is one byte. In alternative embodiments, the size of each part could be longer or shorter than one byte. The result of encoding the message using a multi-stage hashing function is a multi-part encoded message, shown as M₀-Mₙ. The multi-part encoded message can be decoded back into the original message, D₀-Dₙ, by a decoding method. In the illustrated embodiments, each part of the encoded message is one byte. In alternative embodiments, the encoded message portions can be a different length, shorter or longer.

The look up table in the embodiments illustrated in FIGS. 1-3 is a table with 256 rows, where each row of the table corresponds to a one byte random hash value between 0 and 255. In alternative embodiments, the look up table can be a different size and contain different hash values. In some embodiments, the look up table is a vector. The hash table can be randomly filled so that each value between 0 and 255 occurs randomly in one position in the table. Alternatively, the hash table can be well-chosen to reduce the chances of degenerate combinations. For example, undesired looping can occur in a hash table where row 2 has a hash value of 0 and row 0 has the hash value of 2. A well-chosen hash table may ensure that a loop does not occur for less than a certain number of hash values. The corresponding reverse look up table is shown in FIGS. 4-6. In these embodiments, a 256 byte reverse look up table is used to recover the contents of the original message. In alternative embodiments, the reverse look up table can be a different size and contain different hash values. In total, the look up table and reverse look up table in the depicted embodiments each take up 512 bytes of table space.

The key is illustrated in FIGS. 1-3 as K₀-Kₙ and can be obtained in a variety of ways. In some embodiments, the key is 8 bytes long (64 bits) and can be broken into eight separate keys K₀-K₇. In alternative embodiments the key can be a different length and can be obtained in a variety of ways. The method for encoding a message using an augmented multi-stage hash function can include a key exchange algorithm. One example of a key exchange algorithm includes generating a random number and transmitting it as a seed to one or more receivers. All receivers that are authorized to receive the message can perform a cryptographic calculation on that seed to determine the private key. A variety of different key exchange algorithms can be utilized in order to ensure that the transmitter and the receiver have access to the same key. The key can be referenced as a single key with multiple parts or as multiple keys. In either scenario, the multiple portions of the key can be referenced as (K₀-Kₙ).

In one embodiment, the key is made up of a static portion and a dynamic portion, for example a 32 bit static key and 32 bit dynamic key. The static key can be known to every module in the system and may be system specific. Each message type can have an associated static key, thus allowing an assignment of authentication privileges to each control module. For example, if the fuel pump messages are protected by a key only known to the engine and fuel control modules, then the radio module may not be capable of authenticating with it. The dynamic key can be announced to all the modules on some time interval or event. To keep the dynamic key private, it can be sent in an encrypted form which is decoded by each module. The static portion and the dynamic portion can be merged in a predefined order to create the key. For example, 4 static bytes and 4 dynamic bytes may be merged in any order to create an 8 byte key. This static and dynamic key combination serves to protect against playback attacks, and to protect the system against unauthorized senders.

Examples of encoding a message using an augmented multi-stage hashing function will be described. In these examples, n data values are transmitted with a message and the key has a size of n+1. The data values are represented by D₀-Dₙ, the validation value is represented by V, the key values are represented by K₀-Kₙ₊₁, and the encoded message values transmitted on the network are represented by M₀-Mₙ₊₁. The validation value V is a constant known by both the sender and the receiver. In the depicted embodiments, each of the values refers to a byte of data. However, in alternative embodiments, the values can be a different size. Although not depicted in these embodiments, the value used to index into the hash table for the initial data value, D₀, can be XORed with an initialization value. The encoded message values can be saved in a buffer or other memory by a processor in the transmitter so that they can be formed into a packet for transmission to a receiver.

In the illustrated embodiments, the methods of encoding a message using an augmented multi-stage hash function are implemented using an augmented iterative hash function. An iterative hash function generates hash values that correspond to portions of the message where each hash value (except the first) is dependent on the previous hash values. Such a method includes obtaining a dynamic key, obfuscating the message with the dynamic key through a logic operation, and hashing the obfuscated message with an iterative hashing function to obtain two or more hash values that correspond to portions of the obfuscated message. An example of this includes indexing a hash table to determine a first intermediate hash value. The index to look up the first intermediate hash value is generated from a logical operation between a first portion of the message, a first portion of the dynamic key, and an initialization value. A second intermediate hash value can be generated by indexing the hash table. The index to look up the second intermediate hash value can be generated from a logical operation between a second portion of the message, a second portion of the dynamic key, and the first intermediate hash value. This can be repeated until a hash value is generated for each portion of the message. For example, an eight part CAN bus message can generate eight hash values.

The order in which the data bytes are hashed can vary. The examples illustrated in FIGS. 1-3 show each of the data bytes being hashed sequentially with the validation byte being hashed last. In alternative embodiments, the order can be different as long as the transmitter and the receiver know and use the same order for both encoding and decoding. For example, the validation byte can be hashed first, and/or the data bytes can be hashed out of order. The order can be fixed for a particular system so that the order is unknown from system to system. Further, the order can be dynamic and change based on a seed value, such as the key or a separate value known to both the transmitter and the receiver. In some embodiments, the validation byte may not be included in the hash chain; the data may be validated using an alternate validation method.

FIG. 1 illustrates a method of encoding a message using a multi-stage hashing function where a key is XORed with the hash value corresponding to each part of a multi-part message. In the FIG. 1 embodiment, the first byte, D₀, is used as an index into the look up table to obtain a hash value. The hash value is XORed with K₀ in order to obtain M₀ which is the first byte of the encoded message. In the FIG. 1 embodiment, the hash value from D₀ is XORed with D₁ in order to index into the hash table and obtain the second hash value. The second hash value is XORed with K₁ in order to obtain M₁ which is the second byte of the encoded message. This sequence can be repeated for each portion of the message to obtain a corresponding portion of the encoded message. In the depicted embodiment, the validation byte V can be protected and encoded as Mₙ₊₁. The hash value from the last data byte, Dₙ, is XORed with the validation byte and used to index into the look up table. The result of the look up is XORed with the appropriate key byte, Kₙ₊₁, in order to obtain the encoded validation byte, Mₙ₊₁.

FIG. 2 illustrates an embodiment where the result of the XOR between the key and the hash value is XORed with the next part of the message (instead of just the hash value). For example, the first portion of the message D₀ is used as an index to the look up table and the resulting hash value is XORed with the first portion of the key, K₀, and the result is saved in memory as the first encoded portion of the message, M₀. The encoded portion of the message, M₀, is XORed with the second portion of the data, D₁. The result of that XOR is used as an index into the hash table and the result of that look up is XORed with the second portion of the key, K₁ and saved as the second encoded portion of the message, M₁. This process can be repeated for each portion of the message. In the depicted embodiment, the validation byte V can be protected and encoded as Mₙ₊₁. The encoded message from the last data byte, Mₙ, is XORed with the validation byte, V, and used to index into the look up table. The hash value is XORed with the key, Kₙ₊₁, in order to generate the encoded validation byte Mₙ₊₁.

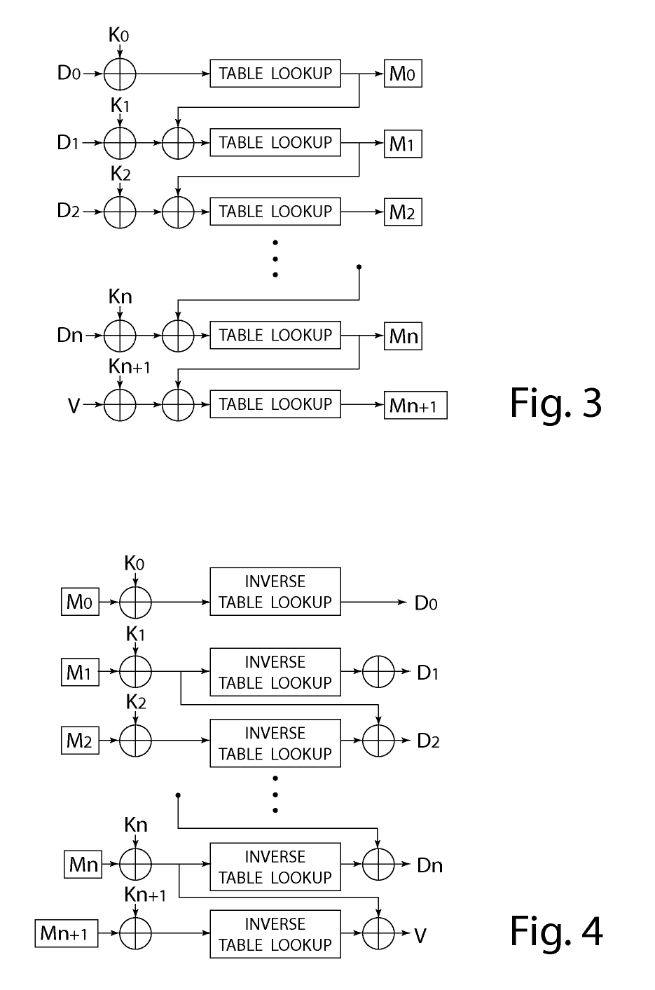

FIG. 3 illustrates another different embodiment where each portion of the message is XORed with the key before being used as the index into the hash table. For example, the first portion of the message D₀ is XORed with the first portion of the key K₀ and the result is used as an index into the look up table. The hash value from the table is saved in memory as the first encoded portion of the message, M₀. The encoded portion of the message, M₀, is XORed with the second portion of the data, D₁, and the second portion of the key, K₁. The result of that XOR is used as an index into the hash table and the result of that look up is saved as the second encoded portion of the message, M₁. This process can be repeated for each portion of the message. In the depicted embodiment, the validation byte V can be protected and encoded as Mₙ₊₁. The encoded message from the last data byte, Mₙ, is XORed with the validation byte, V, and used to index into the look up table. The hash value is XORed with the key, Kₙ₊₁, in order to generate the encoded validation byte Mₙ₊₁.

In the FIGS. 1-3 embodiments, the encoded message portions (M₀-Mₙ) can be transmitted to a receiver that can decode the message. There are a variety of different methods for decoding the message, which are generally dictated by the method for encoding that was employed.

For example, in order to decode a message encoded using the method of augmented multi-stage hashing illustrated in FIG. 1, a method shown in FIG. 4 can be implemented. Specifically, the message M₀ is XORed with K₀ and that value is used as an index into a reverse or reverse look up table. The reverse look up table performs the opposite function as the look up table used in FIG. 1. That is, the random values that were the hash values are used as the index values, and the index values are used as the hash values. The result of the reverse look up provides the first portion of the decoded message, D₀. To obtain the second portion of the decoded message, D₁, the second portion of the message, M₁, is XORed with the second portion of the key K₁ and the result is used as an index in the reverse look up table. The result from the reverse look up is XORed with the result of the XOR between the K₀ and the M₀ that was previously done. This process can be repeated to decode each portion of the encoded message.

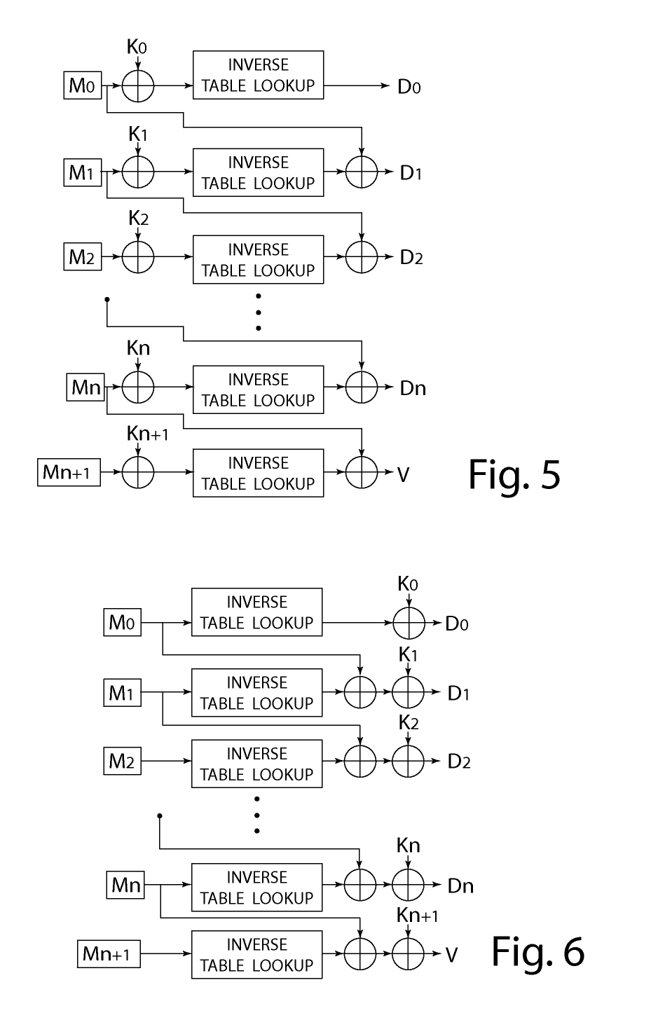

In order to decode a message encoded using the method of augmented multi-stage hashing illustrated in FIG. 2, a method shown in FIG. 5 can be implemented. Specifically, the message M₀ is XORed with K₀ and that value is used as an index into a reverse look up table. The reverse look up table is the reverse of the look up table used in FIG. 2. That is, the random values that were the hash values are used as the index values, and the index values are used as the hash values. The result of the reverse look up will provide the first portion of the decoded message, D₀. To obtain the second portion of the decoded message, D₁, the second portion of the message, M₁, is XORed with the second portion of the key K₁ and the result is used as an index in the reverse look up table. The result from the reverse look up is XORed with the first portion of the encoded message M₀ that was previously done. This process can be repeated to decode each portion of the encoded message.

In order to decode a message encoded using the method of augmented multi-stage hashing illustrated in FIG. 3, a method shown in FIG. 6 can be employed. Specifically, the message M₀ is used as an index into a reverse look up table. The reverse look up table is the reverse of the look up table used in FIG. 3. That is, the random values that were the hash values are used as the index values, and the index values are used as the hash values. The result of the reverse look up is XORed with K₀ to provide the first portion of the decoded message, D₀. To obtain the second portion of the decoded message, D₁, the second portion of the message is used as an index in the reverse look up table. The result from the reverse look up is XORed with the second portion of the key, K₁, and the first portion of the encoded message M₀. This process can be repeated to decode each portion of the encoded message.

Methods of encoding and decoding augmented multi-stage hashing functions can protect against playback attacks, obfuscate message contents, and reject unauthorized messages. Further, these advantages can be realized in low latency, such as real-time systems. Further, the methods provide deterministic results that are platform independent.

It can be desirable to have a large change in the resulting hash being generated from a single bit change in the message. While a simple checksum may not achieve this, a Pearson's hash can through the use of indexing a 256 byte look up table. A sufficiently randomized look up table is a non-computationally-intensive way to achieve large changes in the resulting hash with only a single bit change in the message content. For each step of the Pearson's hash one byte from the data frame is XORed with the previous result (for the first step a constant value is used). The result of this operation is used to index the 256 byte randomized look up table. The value from the look up table is the result of that iteration of the calculation. Once all the data bytes in the frame have been calculated against, the result of the final iteration is considered the hash. The illustrated embodiments shown in FIGS. 1-3 implement a modified version of a Pearson's hash.

Various embodiments of methods of encoding in accordance with the present aspect can include the following characteristics: deterministic execution, occupation of a single byte in the data frame, high entropy validation and single bit dependency, register size independence, and independence between data frames. The various embodiments of this method of encoding do not use conditional statements, which allow calculation time to be precisely modeled for run-time execution modeling. No message data in addition to that already being used by a traditional validation scheme is needed.

The validation byte and other bytes in the message can exhibit high entropy making identification of the calculation methodology a demanding task. Determining the validation value from the other data can be difficult because the data has high entropy, similar to a Pearson's hash. Further, the algorithm does not use shifts, rotates or additions which may be register size dependent. Thus the same C or auto-generated code can be employed on essentially any processor independent of the register size. Some encryption algorithms employ data chaining, requiring that all packets be received or include hamming codes. Lost data frames are possible and even likely in some networks such as a CAN, as such the augmented multi-stage hashing method differs from some popular encryption algorithms in that no message is dependent upon a previous or future message, it is self-contained.

The depicted embodiments of the augmented multi-stage hashing address at least two of the primary drawbacks of the known validation methods. First, it further abstracts the validation calculation by applying high entropy to every byte of transmitted data. Data being transmitted by the augmented multi-stage hashing method is not sent as the raw bytes, rather, a symmetrical mathematical operation is performed prior to transmission and at reception. This operation isn't a simple XOR key that can be easily recovered using statistics, nor is it dependent upon previous data frames. An attacker already presented with (256−1)! possibilities for a hashing table is presented with a further multiplier of 8 for determining which byte is the validation byte. Also, by obscuring which byte holds the validation, transitional observations can be prevented outright. If a count or other excitation is incorporated into the message, high entropy on every byte is displayed even for the case where all underlying data is static. Second, it can prevent playback attacks. A playback attack is where an attacker records a message and then later transmits that same message to instruct a controller to take the recorded action. For example, in the context of a vehicle network, an attacker could copy an anti-lock brake message or an airbag deployment message from one vehicle and play that message back in another vehicle. Playback attacks can be prevented by the augmented multi-stage hashing from one vehicle to another and one ignition cycle to the other. It can do this by way of broadcasting a seed onto the network, such as broadcasting a seed onto a vehicle bus at ignition. Each control module uses that seed to calculate a key by which the mathematics of the validation byte and the obfuscation are performed. For messages present in accessory mode or body control messages, the seed can be updated on a timer, or upon certain events. When an improper key is used on a message, it will not validate with 255/256 probability, and the data contained within will be invalid as well.

An analysis and comparison of some validation schemes is illustrated in Table 1 below. The measurements derived from an eight bit Atmel AVR processor operating at 8 MHz using non-optimized GCC compiled code. These measurements are rolled operations incurring the overhead of a loop; computation time could be reduced at the expense of code space by unrolling the computations. The augmented multi-stage hashing function may be implemented using other bit architecture, such as 32 or 64 bit architecture, other processors such as ARM, PowerPC, and TriCore, and other frequencies.

TABLE 5

| Method | Time (μs) |
|---|---|
| Data buffer copy | 1.46 |
| Checksum | 6.35 |
| Pearson's hash/CRC | 8.30 |
| Augmented Multi-stage Hashing | 11.8 |
| AES-128 | 326 |

Referring to Table 5, the data buffer copy represents the time it takes to transfer a CAN message into the transmission buffer. The checksum method is the time it takes for the addition of the bytes where any carry bits are dropped. The CRC8 method is the time it takes for the standard methodology employed by AutoSar using a 256 byte lookup table. The AES-128 method is shown as a reference to a minimal, publically reviewed encryption algorithm which was coded in optimized assembly The augmented multi-stage hash function can retain the CAN dictionary and message content.

One embodiment of a method for encoding a message using an augmented multi-stage hashing function is described below.

First, in this embodiment, the Pearson's hash is used as a reversible, high entropy calculation. Example pseudo code for the hash can work as follows:

Hash=0;

For bytes in message

Index=message[i]

Hash=Table[index XOr Hash]

In the example, Table refers to a 256 byte randomized look up table and Hash refers to the resulting hash value. The intermediate results of the Hash are stored and can be transmitted together in a packet rather than the data itself. From this, every byte has high entropy.

In some networks, a number of all zero messages may be transmitted. For example, in a vehicle network when the vehicle is off, all zero messages are periodically sent on the CAN bus. This can lead to issues when using the Pearson hash function. The Pearson hash function uses the XOR logical operator, which is the identify function when one of the inputs is zero. This may allow derivation of hash table relationships.

By augmenting a multi-stage hashing function with a dynamic key. The key has at least two benefits; it reduces or prevents the chances of a statistical attack by making zero byte messages result in a non-identity function, and it prevents playback attacks.

Example pseudo code for one embodiment of an augmented multi-stage hash function follows:

Hash=0;

For bytes in message
Index=message[i]
Hash=Table[index XOr Hash XOr Key[i]];

One embodiment of the method for encoding a message using an augmented multi-stage hash function includes a key exchange algorithm. The key exchange algorithm generates a random number and transmits it as a seed to any receivers. All receivers that are authorized to receive the message can perform a cryptographic calculation on that seed to determine the private key. A variety of different key exchange algorithms can be utilized in order to ensure that the transmitter and the receiver have access to the same private key. For example, the key exchange algorithm that is used to obtain diagnostics security access in a vehicle network could be utilized.

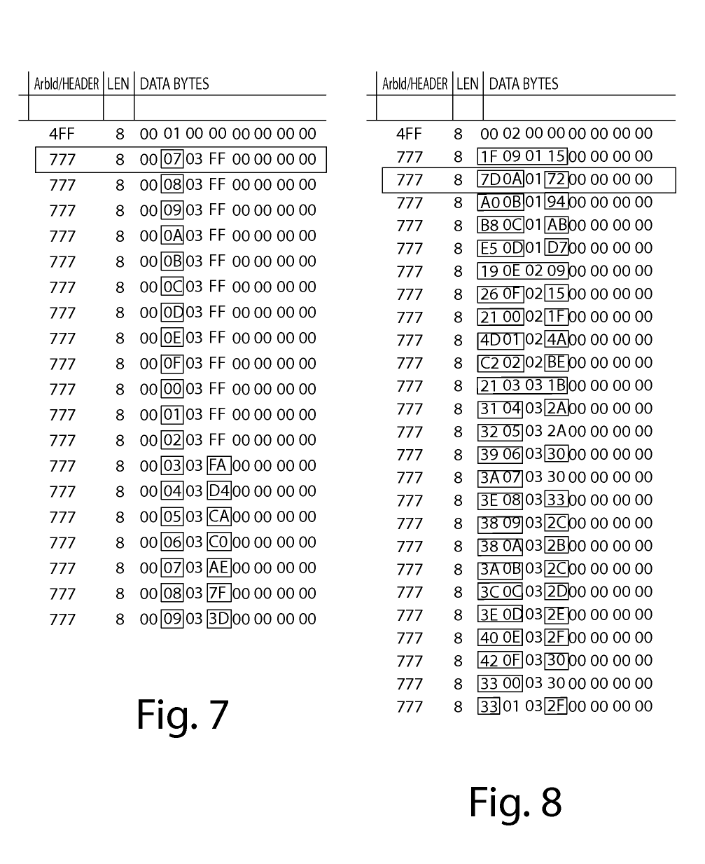

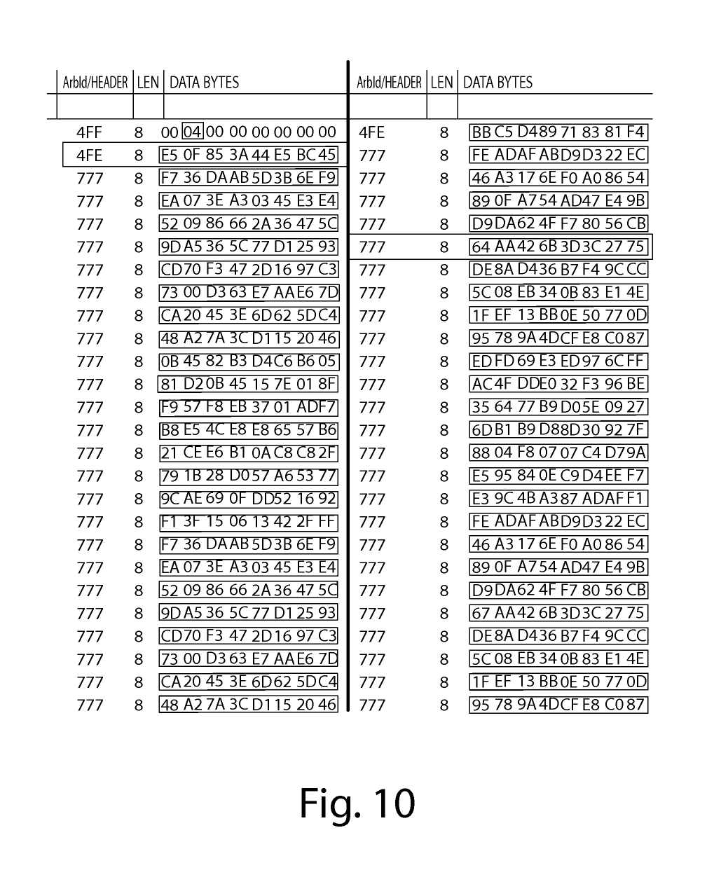

One embodiment of a method of transmitting a message encoded using an augmented multi-stage hashing function is described below in connection with a set of example messages shown in FIG. 10. In order to assist in explaining the encoded messages shown in FIG. 10, an explanation of FIGS. 7-9 is provided below.

Example messages for three different validation modes are provided in FIGS. 7-9. The three examples in FIGS. 7-9 were generated based on an Arduino programmed to take input from a potentiometer and transmit the input as a scaled CAN message that another Arduino can read and use as a command to turn a servo motor. In these examples, the transmitting Arduino communicates which validation mode should be used to the receiving Arduino so that the receiving Arduino can analyze the received message with the appropriate validation technique.

In FIGS. 7-9, each row represents a packet. Each packet contains an arbitration ID, a length, and eight bytes of data. The arbitrationID is a 3 digit hexadecimal number, which can be used to communicate what the message contains. The length indicates the length of the DataBytes field. The length on all of the messages is 8 in the examples, but could be of different sizes in alternative embodiments. The DataBytes field is the message, which may include a validation byte and a command for the servo motor.

FIG. 7 illustrates bus traffic with no validation. The 0x4FF arbitrationID indicates “mode 1” where there is no validation. The servo position information is sent via the packets that have 0x777 arbitrationID. In this example, the first data byte is a non-existent validation byte, for this example this byte is always zero. The second byte is a counter that counts from 0x00-0x0F which the receiving controller can check to make sure it is a new message. This counter byte is common in the field to ensure that a control unit has not gotten stuck in a loop and to indicate that it is indeed a new message even if the contents are the same. The third and fourth bytes are position data. The value of the position may be anywhere from 0x0-0x3FF, which if converted to decimal is 0-1023. This scales to tell the servo to be at 0-180 degrees position. In the FIG. 7 example, the potentiometer was spun, so the position data changes from 0x3FF (max) to 0x33D. The rest of the message is unused and remains zero.

FIG. 8 shows exemplary packets using a checksum validation mode. The first byte of the data is a checksum. The 0x4FF message has a 2 in the second byte, which indicates checksum mode in this example. In checksum mode, the receiving controller adds up the values of the remaining bytes and checks that it matches the first byte before accepting it as a valid command. The potentiometer was moved during the example to provide varied data.

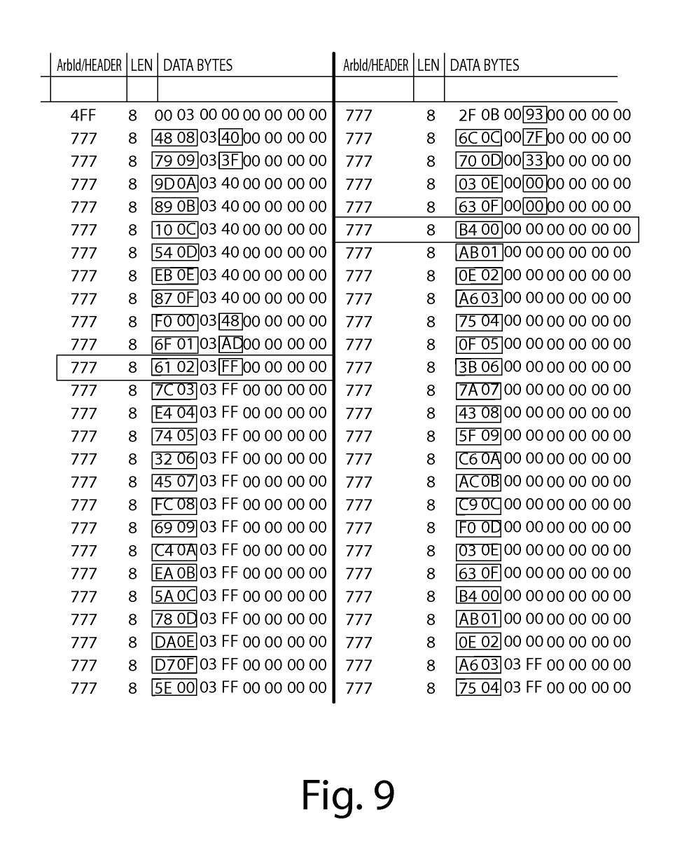

FIG. 9A shows exemplary packets using a Pearson Hash validation mode. A Pearson hash is the first byte of the data. A Pearson's Hash assists in ensuring that the validation byte has high entropy. It appears that there is no obvious way to compute the Pearson Hash validation byte from the data. In order to illustrate this point, FIG. 9B illustrates exemplary packets where all of the data is zero (except the counter). The output has high single bit dependency; change in one bit (the counter) causes large changes in the validation byte. Ultimately, though, with enough data the table can be backed out using the message.

FIG. 10A-B illustrates exemplary packets generated using one embodiment of the method of transmitting a message encoded using an augmented multi-stage hashing function. The first packet shown in FIG. 10A changes the validation mode to the augmented multi-stage hashing function validation protocol. The second packet with 0x4FE as the arbitrationID communicates the dynamic seed, which is a randomly generated value. From this, both the sender and the receiver can privately compute the dynamic key. In this embodiment, this is performed using both a private key and a private algorithm. The remaining data is presented in the same format as described above, with a first validation byte and seven bytes of data. In the depicted packets, all of the position data is zero. The data is obfuscated because the each byte of data was XORed with a portion of the dynamic key (and the previous hash value). In order to decode the message, the receiver uses the key that was computed from the seed, and a reverse look up table.

A new random seed may be transmitted on an event, such as ignition, or on a timer. Once a new seed is used, the same packets will look completely different. This is demonstrated in FIG. 10B by sending a new seed and seeing the new message for zero position come across. The difference in key protects against playback attacks.

Brute forcing messages may cause a validation collision, but the data in the message will likely be invalid due to the fact that it is difficult to know which bytes are used and what they are used for. Additionally, it would only be one message out of many to cause a collision, which would make it very difficult to take over control with many collisions and cause an event to occur.

In the examples above, the hash values and validation value are described in terms of bytes. In alternative embodiments, the portions of the message that are hashed and the size of the validation byte could be longer or shorter. As long as the transmitter and receiver both know the sizes, the method is not limited in such a way.

In the example, the validation value is the first byte of the data, but that need not be the case. In alternative embodiments, the validation byte may be any of the data bytes. Further, the look up table (and reverse or reverse look up table) may come in many forms and may be larger than 256 if desired.

In one embodiment, further playback protection can be added to the method of encoding a message by adding nonce values to the hashing algorithm. Specifically, the step-in value or initialization value of a look up table (the byte used in the first iteration of the algorithm) used in the hashing algorithm can be a nonce value. The nonce value can be distributed to any receivers on the network when it changes. Distributing the value in plaintext would provide a knowledgeable eavesdropper the ability to listen and determine the value. A more secure method of nonce value distribution would be to have a master module transmit a randomized number, and each control module performs an encryption algorithm on that number, possibly seeded with vehicle unique values. The result of the encryption algorithm calculation can be the nonce value. By this method data observed at one time would not be considered authentic if replayed at another time, or in another vehicle. A nonce value is an arbitrary number used only once in a cryptographic communication. Authentication only occurs if the nonce value is correct. This can help ensure that old communications cannot be reused in replay attacks.

The method of transmitting a message encoded using an augmented multi-stage hash function is a process by which small, high frequency data frames can be secured and validated. By way of example, the process can be implemented as an algorithm in software, or realized as physical gates on an integrated circuit. If implemented on a standard 802.3 network (Ethernet) either software on the host computer or hardware within media access controller can run the algorithm and secure the data. A CAN network has a similar relationship between the software of processing messages and the physical layer that executes the CAN protocol. For example, the algorithm can be implemented in the software on the control module or in the CAN physical interface hardware. The method of transmitting a message can modify a data stream of short, repetitive, high frequency data, so that the sender of that data can be validated and the data obscured when traveling over a physical communications channel, so that any listener on the network cannot ascertain the contents of the obscured message.

The method can include a key that is exchanged, either through the same communications channel or a different communications channel. The method of transmitting can include four steps: key exchange, application of the augmented multi-stage hashing function, communication over a network, and reverse operation of the augmented multi-stage hashing function.

The method of transmitting and receiving can be used on essentially any network. That being said, a CAN bus is a representative case of where it may be suitable. Other networks that have short, high frequency data frames may also be suitable, such as the local interconnect network (LIN), UDP communications over 802.3 and 802.11 networks (for applications such as smart grid or future vehicle systems), and Media Oriented Systems Transport (MOST).

While various embodiments refer to CAN communications, targeted at vehicles, the various systems and methods described herein can be implemented in different system. CAN itself is used in a variety of industrial and aerospace applications. The various embodiments can be implemented wherever CAN is employed. However, the usage is not limited to CAN. For example, a smart grid frequency regulation system communicates with a number of small, low power devices at high frequency. To make such a system feasible, the bandwidth consumed per device is minimized. As such lightweight protocols such as UDP are employed over the IP network. On these devices security must be maintained but the computational cost must be minimized as well. The disclosed methods can be applied to UDP packets in the same way it is applied on CAN. The limitations on message length are removed, the key-space could simply be extended to cover the entire message length, e.g. if 96 bit packets are used, a 96 bit key could be applied rather than the 64 bit key described herein.

There are several alternative algorithms that could be employed to apply traditional encryption in lieu of the obfuscation proposed in the augmented multi-stage hash function while still using the seed and nonce exchange method proposed herein. Suitable algorithms could be lightweight cryptography (LWC) implementations such as those designed for RFID and sensor nodes including the PRESENT, Piccolo-80, mCrypton-64/96, Simon, and Speck. These algorithms have been peer reviewed and provide reliable encryption, however they lack certain values. Without a periodic or a continual key exchange system using these algorithms can be susceptible to replay attacks. In these attacks the sender does not need to know the underlying data, only that specific messages achieve their desired effects. Without the nonce/count transmission system, constant underlying data can result in the same cipher data, potentially leaking information.

The terms encode, obfuscate, hash, encrypt, and cryptographic algorithm may be used to generally refer to encoding data in such a way that the original data is difficult to recover, interpret, or counterfeit without privileged information.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method of securing messages in a real-time system having a message computation cost constraint, comprising:
periodically, at regular or irregular intervals, computing a session key using a first cryptographic algorithm, the first cryptographic algorithm having a computation cost greater than an available cryptography portion of the message computation cost constraint;
encoding messages with the session key using a second cryptographic algorithm, the second cryptographic algorithm having a computation cost equal to or less than the available cryptography portion of the message computation cost constraint.

2. The method of securing messages of claim 1 including obtaining a nonce value, wherein the second cryptographic algorithm uses the nonce value to increase the number of messages capable of being encoded before a static message causes a repeated encoded message.

3. The method of securing messages of claim 2 wherein each message includes the nonce value as part of the message.

4. The method of securing messages of claim 2 including periodically receiving at least a portion of the nonce value, and using the portion of the nonce value as a step-in value to the second cryptographic algorithm.

5. The method of securing messages of claim 2 wherein the size and interval of the nonce value is selected to provide sufficient time for re-computing the session key using the first cryptographic algorithm across multiple cycles of a real-time system before a static message causes a repeated encoded message.

6. The method of claim 2 including receiving a slot identifier, storing the nonce value at an address in memory based on the slot identifier, and transmitting the encoded messages with the slot identifier.

7. The method of claim 1 wherein said periodically computing the session key is conducted with a non-repeating seed.

8. The method of claim 1 including pre-computing future session keys using the first cryptographic algorithm based on a predictable seed value.

9. The method of securing messages of claim 1 wherein a plurality of modules on a network each have one or more of a plurality of private keys and one or more of a plurality of versions of the first cryptographic algorithm and each module is capable of decoding messages received from other modules that have at least one private key in common and at least one version of the first cryptographic algorithm in common.

10. The method of securing messages of claim 1 wherein the cryptographic algorithm having the computation cost equal to or less than the available cryptography portion of the message has a break time and said periodically computing a session key occurs within the break time.

11. The method of claim 1 wherein the real-time system is a CAN bus and the session key is computed once per initialization cycle.

12. The method of claim 1 including decoding encoded messages with the session key using a cryptographic algorithm having a computation cost equal to or less than the available cryptography portion of the message computation cost.

13. The method of claim 1 including receiving a slot identifier, storing the computed session key in memory based on the slot identifier, and transmitting the encoded messages with the slot identifier.

14. A method of encoding a message using an augmented multi-stage hashing function comprising:
obtaining a dynamic key;
encoding a first portion of the message using a look up table and a first portion of the dynamic key;
encoding a second portion of the message using a look up table and a second portion of the dynamic key.

15. The method of encoding of claim 14 wherein encoding the second portion of the message includes encoding the second portion of the message using a look up table, a second portion of the dynamic key, and a hash value from the first portion of the message.

16. The method of encoding of claim 14 wherein encoding the second portion of the message includes encoding the second portion of the message using a look up table, a second portion of the dynamic key, and the encoded first portion of the message.

17. The method of encoding of claim 14 wherein encoding the first portion of the message includes an XOR logic operation between a first intermediate hash value from the look up table, and a first portion of the dynamic key, wherein encoding the second portion of the message includes an XOR logic operation between the first intermediate hash value and the second portion of the message, which indexes the look up table to generate a second intermediate hash value, wherein an XOR logic operation between the second portion of the dynamic key and the second intermediate hash value generates the second encoded portion of the message.

18. The method of encoding of claim 14 wherein encoding the first portion of the message includes an XOR logic operation between a first intermediate hash value from the look up table, and a first portion of the dynamic key, wherein encoding the second portion of the message includes an XOR logic operation between the first portion of the encoded message and the second portion of the message, which indexes the look up table to generate a second intermediate hash value, wherein an XOR logic operation between the second portion of the dynamic key and the second intermediate hash value generates the second encoded portion of the message.

19. The method of encoding of claim 14 wherein encoding the first portion of the message includes an XOR logic operation between the first portion of the message and a first portion of the dynamic key and the intermediate hash value from the look up table is the first portion of the encoded message, wherein encoding the second portion of the message includes an XOR logic operation between the first portion of the encoded message, the second portion of the message, and the second portion of the dynamic key, which indexes the look up table to generate a second intermediate hash value that is the second encoded portion of the message.

20. The method of encoding of claim 14 wherein the first portion of the message is 1 byte and the second portion of the message is 1 byte.

21. The method of encoding of claim 14 wherein the first portion of the encoded message and the second portion of the encoded message are arranged in a packet for transmission to a receiver.

22. A method of decoding a message encoded using an augmented multi-stage hashing function comprising:
obtaining a dynamic key;
decoding a first portion of the encoded message using an reverse look up table and a first portion of the dynamic key;
decoding a second portion of the encoded message using an reverse look up table and a second portion of the dynamic key.

23. The method of decoding of claim 22 wherein decoding the second portion of the encoded message includes decoding the second portion of the message using an reverse look up table, a second portion of the dynamic key, and the first portion of the decoded message.

24. The method of decoding of claim 22 wherein decoding the second portion of the message includes decoding the second portion of the message using an reverse look up table, a second portion of the dynamic key, and the encoded first portion of the message.

25. The method of encoding of claim 22 wherein the first portion of the encoded message is 1 byte and the second portion of the encoded message is 1 byte.

26. The method of encoding of claim 22 wherein the first portion of the encoded message and the second portion of the encoded message are arranged in a packet received from a transmitter.

27. A method of transmitting a message encoded using an augmented multi-stage hashing function to a receiver:
obtaining a dynamic key;
generating an encoded validation value and a plurality of encoded message values using an augmented multi-stage hashing function that obfuscates a plurality of intermediate hash values with the dynamic key to generate the encoded validation value and the plurality of encoded message values;
forming a packet for transmission over a network including the plurality of encoded message values and the validation value.

28. The method of transmitting of claim 27 wherein the dynamic key includes a static portion and a dynamic portion, wherein the message includes a message type having an associated static key, wherein providing the static key to the receiver for a particular message type enables authentication of the message for that receiver.

29. The method of transmitting of claim 27 wherein the packet is transmitted over a network having short, high frequency data frames.

30. A method of receiving a packet and decoding a message in the packet encoded using an augmented multi-stage hashing function:
obtaining a dynamic key;
receiving the packet;
decoding the encoded message into the original message using an reverse look up table and the dynamic key.

31. The method of receiving of claim 30 wherein decoding the encoded message into the original message using an reverse look up table and the dynamic key includes iteratively using the reverse look up table and the dynamic key on portions of the message.

32. The method of receiving of claim 30 wherein the dynamic key includes a static portion and a dynamic portion, wherein the message includes a message type having an associated static key.

33. The method of transmitting of claim 30 wherein the packet is received over a network having short, high frequency data frames.
